(19) United States
(12) Patent Application Publication
(10) Pub. No.: US 2026/0131326 A1
(43) Pub. Date: May 14, 2026

(54) DROPLET ACTUATOR USING CONDUCTIVE POLYMER, AND ELECTRODE STRUCTURE THEREOF

(71) Applicant: SEQUREMED INC., Seongnam (KR)

(72) Inventors: Chang Wook MIN, Seoul (KR); Moon Kyung AHN, Yongin (KR)

(21) Appl. No.: 19/021,431

(22) Filed: Jan. 15, 2025

Related U.S. Application Data
(63) Continuation of application No. PCT/KR2023/009390, filed on Jul. 4, 2023.

(30) Foreign Application Priority Data
Jul. 15, 2022 (KR) 10-2022-0087420
Feb. 7, 2023 (KR) 10-2023-0015997

(51) Int. Cl. B01L 3/00; B33Y 80/00

(52) U.S. Cl. CPC B01L 3/502707; B01L 2200/12; B01L 2300/0645; B33Y 80/00

(57) ABSTRACT

The present invention relates to a diagnostic device and a method for manufacturing same. A diagnostic device, according to one embodiment of the present invention, may comprise: a base plate formed of an insulator; and at least one electrode which is formed to penetrate the base plate and which moves a fluid located on the surface on the basis of an applied voltage, wherein the electrode may be formed by injecting a conductive polymer into an empty space of the base plate by using an injection gate.

### TECHNICAL FIELD

The present disclosure relates generally to a droplet actuator using electrowetting and an electrode structure thereof. More specifically, the present disclosure relates to a droplet actuator capable of simplifying a production process by forming an electrode through injection molding, 3D printing, dispensing, laser patterning, or screen printing of a conductive polymer, and to an electrode structure thereof.

### BACKGROUND ART

Electrowetting refers to a phenomenon in which the surface tension of a fluid changes due to an electric field applied to the fluid. For example, a fluid whose surface tension has changed by electrowetting may undergo a change in solid-liquid contact angle due to a potential difference in response to an applied electric signal. For another example, a fluid whose surface tension has been changed by electrowetting may move on an electrode in response to an applied electric signal.

Attempts to utilize this electrowetting are continuously being made in various technological fields. An example of such attempts using electrowetting includes controlling the thickness of camera lenses or commercializing electronic paper.

### DISCLOSURE

### Technical Problem

The technical problem to be solved through some embodiments of the present disclosure is to provide a droplet actuator having a structure capable of simplifying a production process and an electrode structure thereof.

Another technical problem to be solved through some embodiments of the present disclosure is to provide a droplet actuator having a structure capable of lowering the production cost and an electrode structure thereof.

Another technical problem to be solved through some embodiments of the present disclosure is to provide a droplet actuator that can be used as a disposable cartridge and an electrode structure thereof.

The technical problems of the present disclosure are not limited to those mentioned above, and other technical problems not mentioned will be clearly understood by those skilled in the art from the description below.

### Technical Solution

In order to accomplish the above objectives, droplet actuator according to one embodiment may include: a base plate formed of an insulator; and at least one electrode formed through the base plate and configured to move a fluid located on a surface on the basis of an applied voltage. The electrode may be formed by injecting a conductive polymer into an empty space of the base plate using an injection gate.

In one embodiment, the conductive polymer may include a compound of a polymer and a metal.

In one embodiment, the polymer may include siloxane, resin, PLA, ABS, nylon, PETG, TPU, ASA, PEI, or epoxy.

In one embodiment, the metal may include gold (Au), silver (Ag), or copper (Cu).

In one embodiment, the conductive polymer may include a compound of a carbon, carbon nanotubes (CNT), carbon fiber, graphite, or graphene.

In one embodiment, the base plate may be formed by injecting the insulator into a space of a mold using another injection gate that is distinct from the injection gate.

In one embodiment, the base plate may be formed by press molding of the insulator or by flat plate drilling.

In one embodiment, the base plate may be formed by 3D printing of the polymer.

In one embodiment, an upper width of the electrode may be larger than a middle width of the electrode by a first reference size, and a lower width of the electrode may be larger than the middle width of the electrode by a second reference size. The first reference size may be larger than the second reference size.

In one embodiment, a width of the electrode may be tapered from an upper portion toward a middle portion of the electrode, and may be tapered from a lower portion toward the middle portion of the electrode.

### DESCRIPTION OF DRAWINGS

FIG. 1 is an exemplary view illustrating a droplet actuator according to an embodiment of the present disclosure.

FIG. 2 is an exemplary view illustrating an upper portion of an electrode plate described with reference to FIG. 1.

FIG. 3 is an exemplary view illustrating a lower portion of the electrode plate described with reference to FIG. 1.

FIG. 4 is an exemplary sectional view illustrating the electrode plate described with reference to FIG. 1.

FIG. 5 is an exemplary view more specifically illustrating a housing and the electrode plate described with reference to FIG. 1.

FIG. 6 is an exemplary view more specifically illustrating the structure of an electrode described with reference to FIGS. 2 to 4.

FIG. 7 is an exemplary view more specifically illustrating the structure of a base plate described with reference to FIGS. 2 to 4.

FIG. 8 is another exemplary view illustrating the upper portion of the electrode plate described with reference to FIG. 1.

FIG. 9 is a view exemplarily illustrating a reservoir structure according to an embodiment of the present disclosure.

FIGS. 10 to 12 are views more specifically illustrating the reservoir structure illustrated in FIG. 9.

FIG. 13A and FIG. 13B are a view illustrating an electrode structure that facilitates optical observation of a droplet according to an embodiment of the present disclosure.

FIGS. 14 to 18 are views more specifically illustrating the electrode structure illustrated in FIG. 13.

FIG. 19 is an exploded perspective view illustrating an exemplary form of a droplet actuator having a parallel electrode structure according to an embodiment of the present disclosure.

FIG. 20 is a sectional view illustrating a detailed structure of the droplet actuator illustrated in FIG. 19 and an electrowetting operation thereof.

FIG. 21 is an exploded perspective view illustrating an exemplary form of a droplet actuator having a temperature controller according to an embodiment of the present disclosure.

FIG. 22 is a sectional view illustrating a detailed structure of the droplet actuator illustrated in FIG. 21 and a temperature control method using the same.

FIGS. 23 to 25 are views illustrating a droplet actuator having a cleaning function using magnetic force and a cleaning method using the same.

FIG. 26 is a view exemplarily illustrating the configuration of a signal reader that reads test results of a sample of a droplet actuator.

FIG. 27 is a view exemplarily illustrating the configuration of an optical unit illustrated in FIG. 26.

FIGS. 28 to 31 are views more specifically illustrating the configuration and function of a main board illustrated in FIG. 26.

FIG. 32 is a view illustrating a new stacked structure of a droplet actuator according to another embodiment of the present disclosure.

FIG. 33 is a view illustrating a droplet actuator having a vertical electrode structure according to an embodiment of the present disclosure.

FIG. 34A and FIG. 34B are a view illustrating a side view and a plan view of the droplet actuator illustrated in FIG. 33.

FIG. 35 is a view illustrating a switch circuit of the droplet actuator illustrated in FIG. 33.

FIGS. 36A to 37 are views illustrating the operation of electrowetting electrodes according to the operation of the switch circuit illustrated in FIG. 35 and the movement of a droplet thereby.

FIGS. 38 and 39 are views illustrating exemplary electrowetting electrode arrangements of the droplet actuator illustrated in FIG. 33.

FIG. 40 is a view illustrating an exemplary stacked structure of the droplet actuator illustrated in FIG. 33.

FIGS. 41 to 45 are views illustrating an embodiment of a droplet processing method for determining the presence and concentration of a target substance in a droplet.

FIGS. 46 to 49 are views illustrating another embodiment of a droplet processing method for determining the presence and concentration of a target substance in a droplet.

FIGS. 50 to 53 are views illustrating another embodiment of a droplet processing method for determining the presence and concentration of a target substance in a droplet.

FIGS. 54 to 57 are views illustrating another embodiment of a droplet processing method for determining the presence and concentration of a target nucleic acid in a droplet.

FIG. 58 is a flowchart illustrating a droplet processing method using an electrowetting-based droplet actuator according to an embodiment of the present disclosure.

### MODE FOR INVENTION

Reference will now be made in greater detail to exemplary embodiments of the present disclosure with reference to the accompanying drawings. The advantages and features of the present disclosure, and objectives achieved by the present disclosure will become apparent from the detailed description of the following embodiments in conjunction with the accompanying drawings. It should be understood that the present disclosure is not limited to the following embodiments and may be embodied in different ways, and that the embodiments are given to provide complete disclosure of the inventive concept and to provide a thorough understanding of the inventive concept to those skilled in the art. The scope of the present disclosure is defined only by the claims.

As for reference numerals associated with elements in the drawings, it should be noted that the same elements in different drawings are denoted by the same reference numerals. Further, in the following description of the present disclosure, a detailed description of known functions and configurations incorporated herein will be omitted when it is determined that the description may make the subject matter of the present disclosure rather unclear.

Unless otherwise defined, all terms including technical and scientific terms used herein have the same meaning as commonly understood by one of ordinary skill in the art to which this disclosure belongs. It will be further understood that terms, such as those defined in commonly used dictionaries, will not be interpreted in an idealized or overly formal sense unless expressly so defined herein. The terminology used herein is for the purpose of describing particular embodiments only and is not intended to be limiting. As used herein, the singular forms are intended to include the plural forms as well, unless the context clearly indicates otherwise.

Further, terms, such as first, second, A, B, (a), or (b) may be used herein to describe elements of the disclosure. Each of these terms is not used to define essence, order, sequence, or number of an element, but is used merely to distinguish the corresponding element from another element. When it is mentioned that an element is “connected”, “coupled”, or “linked” to another element, it should be interpreted that another element may be “interposed” between the elements or the elements may be “connected”, “coupled”, or “linked” to each other via another element as well as that one element is directly connected or coupled to another element.

It will be further understood that the terms “comprises” and/or “comprising” when used herein, specify the presence of stated features, integers, steps, operations, elements, and/or components, but do not preclude the presence or addition of one or more other features, integers, steps, operations, elements, components, and/or groups thereof.

Hereinafter, various embodiments of the present disclosure will be described in detail with reference to the attached drawings.

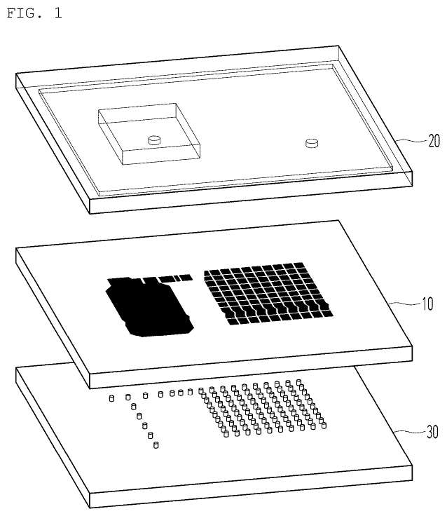

FIG. 1 is an exemplary view illustrating a droplet actuator according to an embodiment of the present disclosure. FIG. 1 illustrates a droplet actuator including an electrode plate 10, a housing 20, and a substrate 30. However, FIG. 1 merely illustrates an exemplary embodiment for achieving the purpose of the present disclosure, and some components may be added or deleted as necessary.

For example, a reader (not illustrated) implemented by a computing device may be further provided. Here, the reader may generate and control an electrowetting signal (i.e., an electric signal) to guide a fluid contained in the housing to a target electrode. Further, each component of the exemplary droplet actuator illustrated in FIG. 1 represents functionally divided functional elements, and it is noted that a plurality of components may be implemented in an integrated form in an actual physical environment. Hereinafter, the components of the exemplary droplet actuator illustrated in FIG. 1 will be described in more detail.

The housing 20 may contain a fluid. At this time, the housing 20 may include a fluid receptacle for containing the fluid. For example, a sample containing DNA may be contained in the fluid receptacle of the housing 20 for polymerase chain reaction (PCR). However, the scope of the present disclosure is not limited to this example.

In some embodiments, the housing 20 may further include a configuration other than the fluid receptacle, depending on an intended use of the droplet actuator. That is, the housing 20 may be configured to provide an additional function in addition to containing the fluid and forming the exterior of the droplet actuator, and it is noted that all technologies of known droplet actuators may be referenced.

Next, the electrode plate 10 may induce polarization within a droplet through the electrowetting signal to move the droplet distributed from the fluid contained in the housing 20 to the position of a target electrode. At this time, the electrode plate 10 may include at least one electrode for conducting the electrowetting signal.

In some embodiments, the electrode plate 10 may include a base plate and at least one electrode formed through the base plate. Here, the base plate may be formed of an insulator. According to the present embodiment, electrowetting may be used to change the surface tension between the electrode and the droplet along the electrode formed through the electrically insulated base plate. The change in the surface tension causes a change in the contact angle between the electrode and the droplet, allowing the droplet to move between adjacent electrodes. A more detailed description of the structure of the electrode formed in the electrode plate 10 will be embodied later through description herein.

Next, the substrate 30 may transmit the electrowetting signal to the electrode plate 10. For example, the substrate 30 may be any one of a glass substrate, a silicon substrate, a printed circuit board (PCB), and a thin film transistor (TFT). However, the scope of the present disclosure is not limited to these examples, and any known technology having a structure capable of transmitting an electrowetting signal sent by the reader (not illustrated) to the electrode plate 10 may be applied to the present disclosure.

In some embodiments, a reader (not illustrated) implemented as a computing device may be included in the droplet actuator. However, in an environment where the droplet actuator is manufactured as a disposable product and a plurality of droplet actuators are connected to the reader via a connector and used one time, it is possible to reduce the manufacturing cost of the droplet actuator by excluding the reader as in the case illustrated in FIG. 1.

According to the exemplary droplet actuator according to the embodiment of the present disclosure described above with reference to FIG. 1, it may distribute a droplet from the fluid contained in the housing 20 and move the droplet to the position of a target electrode.

The droplet actuator described above may be used as a diagnostic device. Using the droplet actuator, it is possible to automatically extract and purify the cells, vesicles, proteins, nucleic acids, etc. from a sample such as blood, urine, feces, saliva, nasopharyngeal smear, nasal cavity, oropharyngeal smear, cerebrospinal fluid, skin tissue, hair, other body cells, body tissue, semen; to perform gene amplification, detoxification, synthesis, and diagnosis; to perform immunodiagnosis using antigen-antibody reactions; and to synthesize and manufacture compounds. Further, it is also possible to test heavy metals, toxic substances against human body, and drugs. However, the technical fields where the droplet actuator described above can be used are merely illustrative, and it is noted that the droplet actuator may be used in other various technical fields.

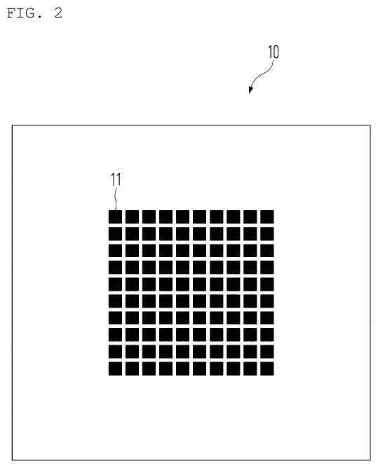

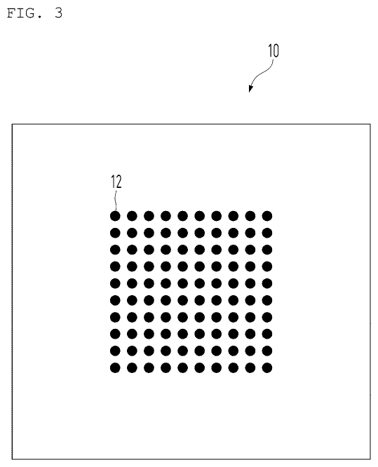

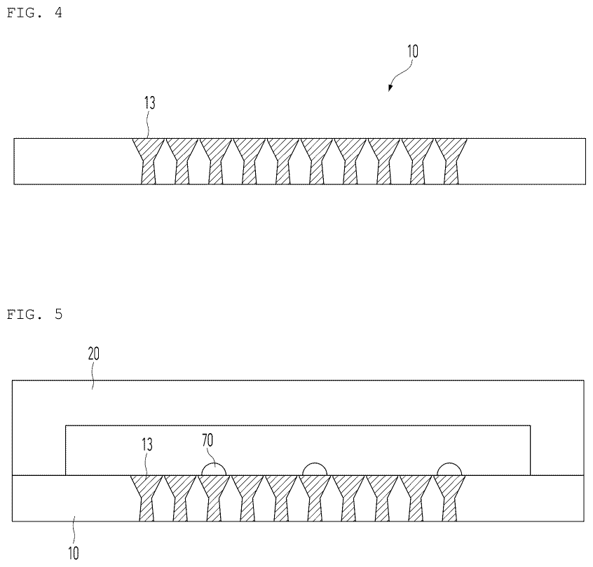

Hereinafter, the structure of the electrode plate 10 will be described in more detail with reference to FIGS. 2 to 4. FIG. 2 is an exemplary view illustrating an upper portion of the electrode plate 10 described with reference to FIG. 1. FIG. 3 is an exemplary view illustrating a lower portion of the electrode plate 10 described with reference to FIG. 1. FIG. 4 is an exemplary sectional view illustrating the electrode plate 10 described with reference to FIG. 1.

FIG. 2 illustrates an exemplary structure of an upper portion 11 of an electrode formed on an upper portion of the electrode plate 10. The upper portion 11 of the electrode illustrated in FIG. 2 is formed in a square shape, but it is noted that this is merely exemplary and the structure of the upper portion 11 of the electrode may vary.

FIG. 3 illustrates an exemplary structure of a lower portion 12 of an electrode formed on a lower portion of the electrode plate 10. The lower portion 12 of the electrode illustrated in FIG. 3 is formed in a circular shape, but it is noted that this is merely exemplary and the structure of the lower portion 12 of the electrode may vary.

FIG. 4 illustrates an exemplary side structure of an electrode. Referring to FIG. 4, the electrode 13 may be formed through the base plate. With respect to the electrode, in some embodiments, the electrode may be formed by injection molding, 3D printing, screen printing, laser patterning, or dispensing of a conductive polymer. The conductive polymer may include a conductive plastic. According to the present embodiment, it is possible to manufacture the electrode of the droplet actuator in a simple process without requiring a complex process similar to a semiconductor process including photolithography, metal deposition, etc.

With respect to the electrode, in some other embodiments, the conductive polymer constituting the electrode may include a compound of a polymer and a metal. At this time, the polymer may include siloxane, epoxy, resin, ABS, PLA, TPU, HIPS, or the like. In addition, the metal may include gold (Au), silver (Ag), copper (Cu), or other conductive metal materials. At this time, the conductive polymer may include at least one of conductive materials, such as carbon nanotubes (CNTs), carbon fiber, graphite, and graphene, along with the metal.

With respect to the electrode, in some other embodiments, the conductive plastic constituting the electrode may include a mixture of polycarbonate (PC), poly methyl methacrylate (PMMA), cyclic olefin polymer (COP), cyclic olefin copolymer (COC), polyethylene terephthalate (PET), polyimide (PI), polyethylene (PE), acrylic, acrylonitrile butadiene styrene (ABS), polyvinylidene fluoride (PVDF), polytetrafluoroethylene (PTFE), polystyrene (PS), polypropylene (PP), and polyvinyl chloride (PVC). At this time, the mixture may include at least one of conductive materials, such as carbon nanotubes, graphene, carbon fiber, gold, silver, and copper, along with the polymers. In addition, it is noted that any known mixture for conducting an electric signal may be applied to the present disclosure for the manufacture of the electrode.

With respect to the base plate, in some embodiments, the insulator constituting the base plate may include at least one of polycarbonate (PC), poly methyl methacrylate (PMMA), cyclic olefin polymer (COP), cyclic olefin copolymer (COC), polyethylene terephthalate (PET), polyimide (PI), polyethylene (PE), acrylic, acrylonitrile butadiene styrene (ABS), polyvinylidene fluoride (PVDF), polytetrafluoroethylene (PTFE), polystyrene (PS), polypropylene (PP), and polyvinyl chloride (PVC). In addition, it is noted that any known composition including a thermoplastic resin for conducting an electric signal may be applied to the present disclosure for the manufacture of the insulator.

With respect to the electrode and base plate, in some embodiments, the base plate may be formed primarily, and then the conductive polymer may be injected into a space of the base plate using an injection gate (or nozzle) secondarily.

At this time, in one embodiment, the base plate may be formed by injecting the insulator into a space of a mold using another injection gate that is distinct from the injection gate.

Alternatively, in another embodiment, the base plate may be formed by press molding of the insulator or by flat plate drilling.

Alternatively, in another embodiment, the base plate may be formed by 3D printing using siloxane, resin, ABS, PLA, TPU, nylon, PETG, ASA, PEI, HIPS, or the like.

With respect to the electrode and the base plate, in some embodiments, the electrode and the base plate may be formed by double shot injection molding. More specifically, the base plate may be formed by injecting the insulator into a first space of a first mold using a first injection gate (or nozzle), and the electrode may be formed by injecting the conductive polymer into a second mold or a second space of the first mold using a second injection gate (or nozzle) that is distinct from the first injection gate. Here, the first injection gate and the second injection gate may be configurations included in an injector having two or more injection gates. However, the scope of the present disclosure is not limited thereto, and the first injection gate and the second injection gate may be configurations included in different injectors each having a single injection gate. According to the present embodiment, it is possible to manufacture the electrode and the base plate formed of different materials in a simple process without requiring a complex process similar to a semiconductor process including photolithography, metal deposition, etc. In order to manufacture the electrode and the base plate formed of different materials, any known method for performing double shot injection molding may be applied to the present disclosure.

With respect to the electrode and the base plate, in some other embodiments, the electrode and the base plate may be formed by insert injection molding or overmolding. More specifically, the base plate may be formed by injecting the insulator into the first mold, and the electrode may be formed by inserting the resultant base plate into the second mold and then injecting the conductive polymer into the second mold. On the contrary, the electrode may be formed by injecting the conductive polymer into a third mold, and the base plate may be formed by inserting the resultant electrode into a fourth mold and then injecting the insulator into the fourth mold. According to the present embodiment, it is possible to manufacture the electrode and the base plate formed of different configurations in a simple process without requiring a complex process similar to a semiconductor process including photolithography, metal deposition, etc.

In addition to the double shot injection molding, the insert injection molding, and the overmolding described above, it is noted that various techniques for injection molding with different materials to manufacture products composed of two or more different materials may be included within the scope of the present disclosure.

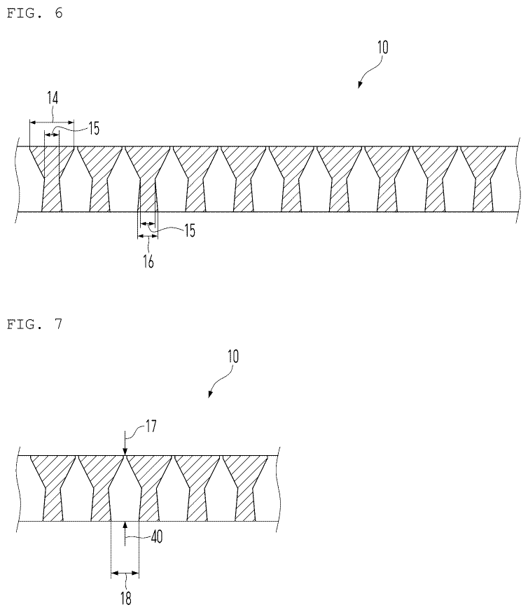

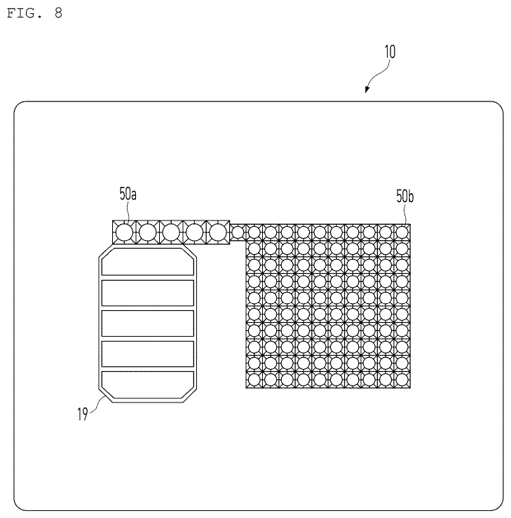

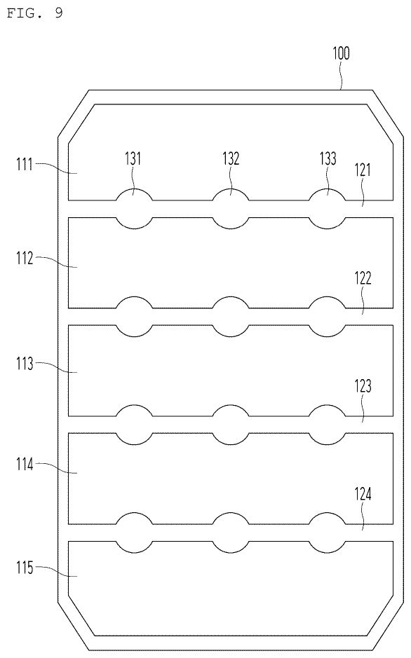

As shown in FIG. 5, the housing 20 may be coupled to the upper portion of the electrode plate 10 which may be formed according to the various methods described above. Here, the fluid contained in the fluid receptacle (not illustrated) of the housing 20 may be distributed into droplets on the basis of the electrowetting signal and moved along the electrode 13 formed in the electrode plate 10. In some embodiments, the droplets may be moved to a position and/or a direction guided by the electrowetting signal, through a space between an upper surface of the electrode 13 formed in the electrode plate 10 and a lower surface of a housing facing the upper surface of the electrode. FIG. 5 illustrates an example of a droplet 70 moving along the electrode 13 on the basis of the electrowetting signal. The movement of the droplet distributed from the fluid contained in the fluid receptacle (not illustrated) of the housing 20 will be described in detail later with reference to FIG. 8. Hereinafter, the structure of the electrode and the base plate included in the electrode plate 10 will be described in more detail with reference to FIGS. 6 and 7. FIG. 6 is an exemplary view more specifically illustrating the structure of the electrode described with reference to FIGS. 2 to 4, and FIG. 7 is an exemplary view more specifically illustrating the structure of the base plate described with reference to FIGS. 2 to 4. The electrode illustrated in FIG. 6 and the base plate illustrated in FIG. 7 are examples provided only for explaining some embodiments of the present disclosure, and thus the scope of the present disclosure is not limited to the structures illustrated in FIGS. 6 and 7.

Referring to FIG. 6, an upper width 14 of the electrode formed in the electrode plate 10 is larger than a middle width 15 of the electrode by a first reference size, and a lower width 16 of the electrode is larger than the middle width 15 of the electrode by a second reference size. Here, a middle portion of the electrode may refer to any location between the upper and lower portions of the electrode. In some embodiments, the location of the middle portion of the electrode may vary depending on an intended use of the droplet actuator, and it is construed that any electrode may be included within the scope of the present disclosure as long as it has a structure in which the middle width 15 of the electrode is formed smaller than the upper width 14 of the electrode and the lower width 16 of the electrode. Further, it is noted that the first reference size and the second reference size may vary depending on an intended use of the droplet actuator.

With respect to the reference size, in some embodiments, the first reference size may be larger than the second reference size. Since the upper portion of the electrode plate 10 is a part that comes into contact with the droplet and the lower portion of the electrode plate 10 is a part where an electric signal is conducted, the upper width 14 of the electrode may be preferably larger than the lower width 16 of the electrode.

With respect to the electrode, in some embodiments, the width of the electrode may be tapered from the upper portion toward the middle portion of the electrode, and may be tapered from the lower portion toward the middle portion of the electrode. According to the present embodiment, by increasing the adhesion between the electrode and the base plate formed of different configurations, it is possible to increase the yield of the manufactured electrode plate 10 and reduce the defect rate thereof.

With respect to the electrode, in some other embodiments, the electrode may be formed such that the upper width of the electrode is larger than or equal to the middle width of the electrode, and the middle width of the electrode is larger than or equal to the lower width of the electrode. In some embodiments, the electrode may be formed in a shape that is tapered from the upper portion toward the lower portion thereof.

The structure of electrodes according to some embodiments has been described above by referring to FIG. 6. However, it is noted that, unlike the illustration in FIG. 6, the upper width 14, the middle width 15, and the lower width 16 of the electrode may each vary as necessary.

FIG. 7 illustrates an exemplary electrode gap formed by two or more electrodes formed in the electrode plate 10. Here, the electrode gap may be the base plate portion formed of the insulator.

With respect to the electrode gap, in some embodiments, an upper width 17 of the electrode gap may be smaller than a lower width 18 of the electrode gap. Here, the base plate of the electrode gap may be formed by placing the injection gate under a lower portion 40 of the electrode gap and injecting the insulator. By forming the lower width 18 of the electrode gap to be larger than the upper width 17 of the electrode gap, it is possible to reduce the pressure generated when injecting the insulator constituting the base plate. By reducing the pressure generated when injecting the insulator, it is possible to increase the yield of the manufactured electrode plate 10 and reduce the defect rate thereof.

With respect to the electrode gap, in some other embodiments, the width of the electrode gap may be tapered from the middle portion toward the upper portion of the electrode gap, and may be tapered from the middle portion toward the lower portion of the electrode gap. According to the present embodiment, by increasing the adhesion between the electrode and the base plate formed of different configurations, it is possible to increase the yield of the manufactured electrode plate 10 and reduce the defect rate thereof.

Hereinafter, a reservoir 19 and electrodes 50a and 50b, which may be included in the electrode plate 10, will be described in more detail with reference to FIG. 8. FIG. 8 is another exemplary view illustrating the upper portion of the electrode plate described with reference to FIG. 1.

As illustrated in FIG. 8, the electrode plate 10 may further include the reservoir 19 that dispenses the fluid contained in the housing 20. According to the present embodiment, the fluid contained in the housing 20 may primarily flow into the reservoir 19. In addition, the reservoir 19 according to the present disclosure may be formed in various structures for dispensing the fluid to adjacent electrodes. For example, a structure in which a fluid directly flows into the reservoir 19 from the outside without passing through the housing 20 is not excluded from the scope of the present disclosure.

Further, as illustrated in FIG. 8, the adjacent electrode 50a formed adjacent to the reservoir 19 may have an upper width larger than an upper width of the other electrode 50b. Compared to the other electrode 50b, the adjacent electrode 50a is located closer to the reservoir 19, so it may be located on a path through which the droplet distributed from the fluid inevitably moves on the basis of the electrowetting signal. Therefore, in order for the adjacent electrode 50a to contain a larger amount of droplet than that in the other electrode 50b or to induce electrowetting by applying voltage to a large amount of droplet, the adjacent electrode 50a may be formed to have a relatively larger size than the other electrode 50b.

With respect to adjacent electrode, in some embodiments, the number of adjacent electrodes 50a may be determined on the basis of the size of the reservoir 19. For example, the number of adjacent electrodes 50a may be increased as the size of the reservoir 19 increases, and the number of adjacent electrodes 50a may be decreased as the size of the reservoir 19 decreases. The number of adjacent electrodes 50a illustrated in FIG. 8 is five, but it is noted that this is merely exemplary and the scope of the present disclosure is not limited thereto.

The droplet actuator according to the embodiment of the present disclosure has been described above by referring to FIGS. 1 to 8. According to the present embodiment, unlike conventional droplet actuators in which metal electrodes are deposited and formed, the droplet actuator may be manufactured in a simple process. By simplifying the manufacturing process of the droplet actuator according to the present embodiment, it is possible to reduce the manufacturing cost of the droplet actuator, and reduce the manufacturing cost of the droplet actuator to a manufacturing cost suitable for use as a disposable cartridge (or disposable kit).

In addition, according to the present embodiment, compared to a conventional droplet actuator manufacturing process including photolithography, metal deposition, etching, etc., it is possible to provide a droplet actuator with a structure capable of increasing the yield and reducing the defect rate through a very simple injection molding process.

Further, according to the present embodiment, it is possible to provide a droplet actuator with a structure that allows smooth flow of the fluid contained in the housing along the reservoir and the electrode on the basis of the electrowetting signal.

Hereinafter, described will be a reservoir structure for increasing the injection productivity and further reducing the defect rate of the droplet actuator according to the present disclosure.

FIG. 9 is a view exemplarily illustrating a reservoir structure according to an embodiment of the present disclosure. Referring to FIG. 9, a reservoir 100 according to the present embodiment includes a plurality of regions 111, 112, 113, 114, 115 in each of which an electrode is formed, and a plurality of walls 121, 122, 123, 124 located between the plurality of regions 111, 112, 113, 114, 115 to separate the regions from each other.

Unlike the reservoir 19 illustrated in FIG. 8, the reservoir 100 according to the present embodiment has at least one extension portion 131, 132, 133 formed on each wall 121, 122, 123, 124.

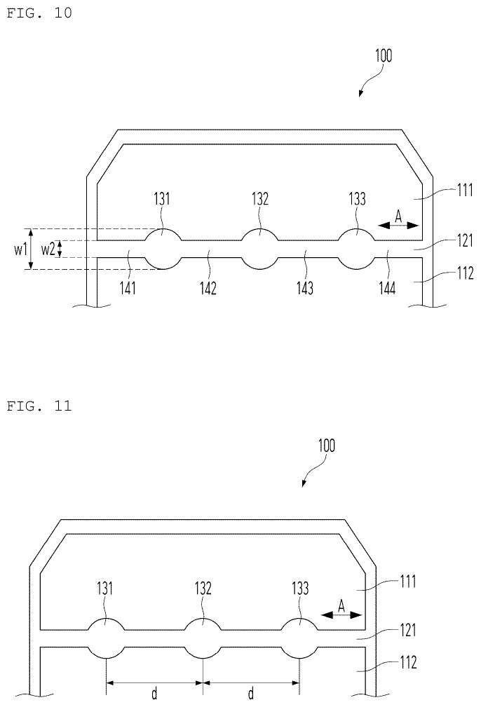

This will be described in more detail with reference to FIGS. 10 to 12.

FIG. 10 is an excerpt view illustrating a portion of the reservoir 100 illustrated in FIG. 9.

In FIG. 10, the reservoir 100 includes a first region 111, a second region 112 adjacent to the first region 111, and a first wall 121 between the first region 111 and the second region 112.

In one embodiment, electrodes may be formed in the first region 111 and the second region 112 by injecting the conductive polymer through injection molding.

Further, the first wall 121 has at least one extension portion 131, 132, 133 formed along a longitudinal direction A of the first wall 121 and having a width increased compared to peripheral portions 141, 142, 143, 144.

Here, the peripheral portions 141, 142, 143, 144 refer to parts of the first wall 121 and are formed at positions adjacent to the extension portions 131, 132, 133.

As such, by forming the extension portions 131, 132, 133 having a width w1 that is increased compared to a width w2 of the peripheral portions 141, 142, 143, 144 in the first wall 121, it is possible for the first wall 121 to better withstand the injection pressure caused by injection molding when forming an electrode in the first region 111 or the second region 112.

For example, in the reservoir 19 illustrated in FIG. 8, when the conductive polymer is injected to form an electrode, there are often cases where each wall between adjacent regions cannot withstand the injection pressure and eventually bends.

On the contrary, in the reservoir 100 according to the present embodiment, the extension portions 131, 132, 133 formed along the first wall 121 have an increased width w1 to more strongly resist the injection pressure during the injection of the conductive polymer, thereby minimizing such a bending phenomenon of the first wall 121.

Meanwhile, with the reservoir 100 according to the embodiment, it is possible to reduce the defect rate of a product by preventing bending of the first wall 121, and contribute to increasing the productivity of the product.

For example, in the reservoir 19 illustrated in FIG. 8, in order to prevent bending of the wall, the reservoir portion had to be injected more precisely from the injection step of the base plate, which resulted in a problem of lowering the overall product productivity. However, in the reservoir 100 according to the present embodiment, since the bending phenomenon of the wall is alleviated by the extension portions 131, 132, 133, there is no burden of having to precisely inject the reservoir portion during the injection step of the base plate unlike the conventional case. Accordingly, the overall product productivity may also be improved.

Meanwhile, in the present embodiment, the extension portions 131, 132, 133 may have a cylindrical shape with a circular cross-section, but the scope of the present disclosure is not limited thereto. For example, the extension portions 131, 132, 133 may be a column having an elliptical or polygonal cross-section, or a closed figure made up of straight lines and curves. Here, the cross-section refers to a cross-section obtained by cutting the extension portions 131, 132, 133 along the longitudinal direction A of the first wall 121.

In one embodiment, the extension portions 131, 132, 133 may be formed apart from each other by a predetermined distance along the first wall 121. This will be described in detail with reference to FIG. 11.

In FIG. 11, the extension portions 131, 132, 133 are formed at positions spaced apart from each other by a predetermined distance d. That is, among the extension portions 131, 132, 133, a second extension portion 132 may be formed at a position a distance d away from a position where a first extension portion 131 is formed, and a third extension portion 133 may be formed at a position a distance d away from a position where the second extension portion 132 is formed.

This is to ensure that when injecting the conductive polymer into each region 111, 112, each extension portion 131, 132, 133 evenly shares the injection pressure and effectively supports the first wall 121.

For example, it is assumed that the extension portions 131, 132, 133 are formed biased on the left side of the first wall 121. At this time, when the conductive polymer is injected, a relatively large injection pressure is applied to the third extension portion 133 located on the far right, and the third extension portion 133 may not be able to withstand the excessive injection pressure but bends or be damaged. In addition, in this case, since the right side of the first wall 121 is relatively far from the extension portions 131, 132, 133, it may not be supported by the extension portions 131, 132, 133 and be highly likely to bend due to the injection pressure.

Therefore, as illustrated in FIG. 11, it is preferable that the extension portions 131, 132, 133 are arranged at equal intervals by a predetermined distance d.

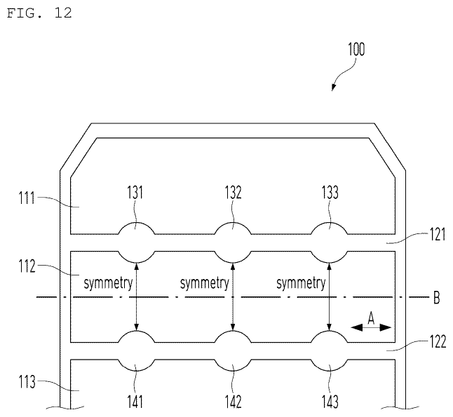

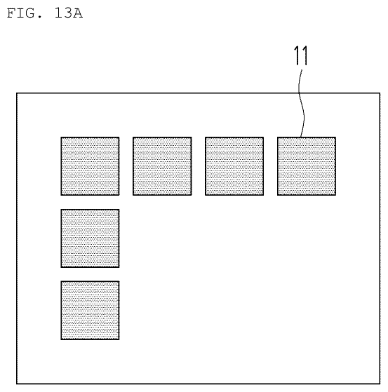

Meanwhile, in one embodiment, the extension portions formed on each wall of the reservoir 100 may be formed at positions symmetric to each other. This will be described in more detail with reference to FIG. 12.

Referring to FIG. 12, illustrated is a portion of the reservoir 100 including the first region 111, the second region 112, and the third region 113. The first wall 121 and the second wall 122 each having at least one extension portion are formed between the regions 111, 112, 113.

As described in the previous embodiments, the first wall 121 is located between the first region 111 and the second region 112 to separate the regions 111, 112 from each other. Also, at least one extension portion 131, 132, 133 is formed on the first wall 121. The extension portions are spaced apart from each other at equal intervals along the longitudinal direction of the first wall 121.

Similarly, the second wall 122 is located between the second region 112 and the third region 113 to separate the regions 112, 113 from each other. Also, at least one other extension portion 141, 142, 143 is formed on the second wall 122. The other extension portions are spaced apart from each other at equal intervals along the longitudinal direction A of the second wall 122.

At this time, the other extension portions 141, 142, 143 may be formed at symmetric positions with the extension portions 131, 132, 133. Here, the term “symmetric” means that the extension portions 131, 132, 133 and the other extension portions 141, 142, 143 are formed at respective positions facing each other with respect to a center line B of the second region 112.

This may contribute to increasing the structural stability of each wall 121, 122 when the conductive polymer is simultaneously injected into each region 111, 112, 113 of the reservoir 100. For example, when the extension portions 131, 132, 133 and the other extension portions 141, 142, 143 are formed at non-symmetric positions, turbulence may be more likely to occur in the second region 112 in terms of fluid dynamics, and a stronger local pressure may be applied to the first wall 121 or the second wall 122.

Therefore, in order to distribute the pressure applied to each part of the walls 121, 122 as evenly as possible, the extension portions 131, 132, 133 and the other extension portions 141, 142, 143 are preferably formed at mutually symmetric positions.

With the reservoir structure according to the present disclosure which has been described through the above embodiments, it is possible to minimize the bending phenomenon of each wall during injection molding of the conductive polymer, thereby improving the injection productivity and reducing the product defect rate. As a result, it is possible to simplify the production process and reduce the production cost.

Hereinafter, described will be an electrode structure that makes optical observation of a droplet easier in the droplet actuator according to the present disclosure.

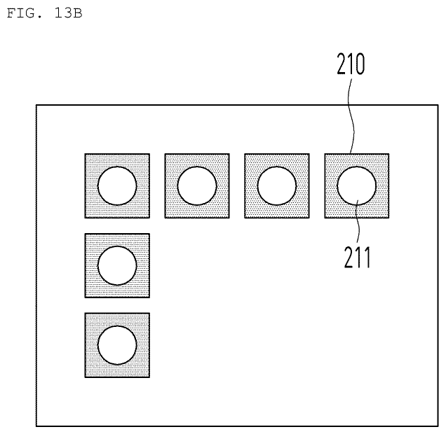

FIG. 13 is a view illustrating an electrode structure that facilitates optical observation of a droplet according to an embodiment of the present disclosure. FIG. 13A illustrates a conventional electrode structure, and FIG. 13B illustrates an electrode structure according to the present embodiment.

Referring to FIG. 13A, the conventional electrode structure has an electrode 11 that is entirely filled with an opaque conductor, for example, a conductive polymer. Therefore, there is a problem in that a droplet located on the electrode 11 is obscured by the opaque conductor, making optical observation of the droplet difficult.

Meanwhile, referring to FIG. 13B, the electrode structure according to the present embodiment has a hole 211 that is not filled with an opaque conductor and is formed inside an electrode 210. Accordingly, a droplet located on the electrode 210 may be directly observed through the hole 211, making optical observation of the droplet and light emitted from the droplet easy.

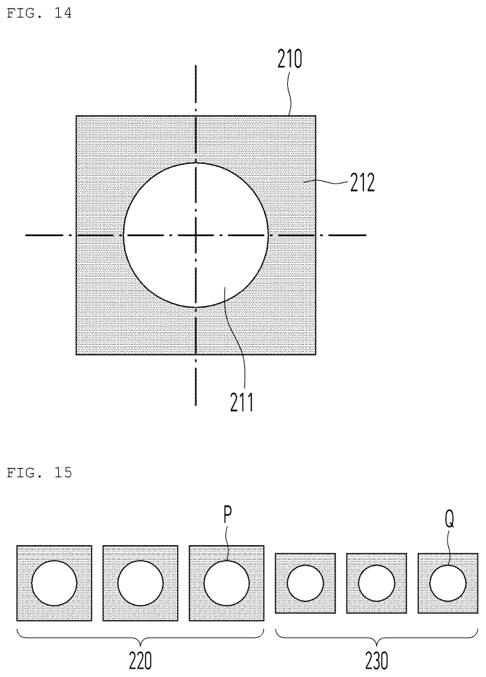

FIGS. 14 to 18 are views more specifically illustrating the electrode structure illustrated in FIG. 13.

FIG. 14 is an enlarged view more specifically illustrating the electrode 210 illustrated in FIG. 13. Referring to FIG. 14, the electrode 210 includes the hole 211 located at a center of the electrode 210 and a peripheral portion 212.

As described above, the hole 211 is a configuration formed inside the electrode 210 and not filled with the opaque conductor.

In one embodiment, an interior of the hole 211 may be empty or filled with a transparent conductor or insulating material.

In one embodiment, the hole 211 may be located at the center of the electrode 210 as illustrated in FIG. 13.

The peripheral portion 212 is a part of the electrode 210 surrounding the hole 211 and is filled with the opaque conductor. In one embodiment, the opaque conductor may be a conductive polymer.

According to the electrode 210 illustrated in FIG. 14, the droplet located on the electrode 210 may be guided in a specific direction by a potential or an electric signal applied to the peripheral portion 212, and the droplet and the light emitted from the droplet may be optically observed through the hole 211 of the electrode 210. Therefore, it is possible to provide an electrode structure that enables optical observation of the droplet while performing guidance of the droplet by electrowetting without any problem.

Meanwhile, in the present embodiment, the hole 211 is exemplified as being circular, but the scope of the present disclosure is not limited thereto. For example, the hole 211 may have an oval or polygonal shape in addition to a circular shape.

In one embodiment, the size of the hole 211 may be increased as the size of the electrode 210 increases. This will be described in detail with reference to FIG. 15.

FIG. 15 illustrates a plurality of electrodes 220, 230 having different sizes. The droplet actuator according to the present disclosure may simultaneously include electrodes of different sizes. For example, referring to the example of FIG. 8, the electrode 50a located adjacent to the reservoir 19 may have a larger size than the other electrode 50b.

As such, when a single droplet actuator has electrodes of different sizes, a hole P formed in the larger electrode 220 may have a larger size than a hole Q formed in the smaller electrode 230.

As the size of the hole is increased, the area for observing a droplet becomes wider, making optical observation of the droplet easier. However, in this case, since the area of a peripheral portion filled with a conductor is reduced, a force that guides the droplet may be reduced. Therefore, in order to secure a minimum force to guide the droplet, the size of the hole Q in the small electrode 230 needs to be limited to less than a predetermined level. On the other hand, in the case of the large electrode 220, since the area of the peripheral portion is secured at a predetermined level even when the size of the hole P is increased, it is possible to form a hole of a larger size compared to the case of the small electrode 230.

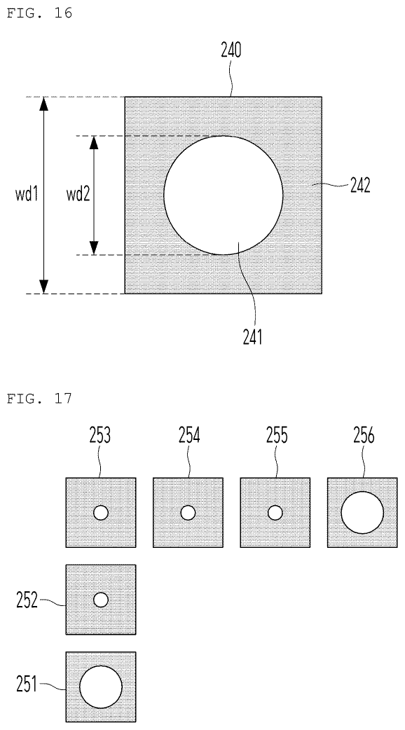

In one embodiment, the ratio of the size of the hole to the size of the electrode may be limited within a predetermined range. This will be described in detail with reference to FIG. 16.

As described above with reference to FIG. 15, when the size of a hole 241 is increased, optical observation of a droplet becomes easier, but the area of a peripheral portion 242 is reduced accordingly, so a force that guides the droplet may be reduced. Therefore, the ratio of the size of the hole 241 to the size of an electrode 240 may be adjusted within an appropriate range, thereby achieving both optical observation of the droplet and guidance of the droplet by electrowetting.

In one embodiment, the ratio of the size of the hole to the size of the electrode may be the ratio of widths. In the example of FIG. 12, the electrode 240 is a square with a width of wd1, and the hole 241 is a circle with a width of wd2. In this case, the ratio R of the size of the hole to the size of the electrode may be wd2/wd1.

In another embodiment, the ratio of the size of the hole to the size of the electrode may be the ratio of areas. Referring again to the example of FIG. 16, the area of the electrode 240 is wd1\hat{ }2, and the area of the hole 241 is π*(wd2/2)\hat{ }2. In this case, the ratio R of the size of the hole to the size of the electrode may be π*(wd2/2)\hat{ }2/wd1\hat{ }2.

In one embodiment, the ratio R of the size of the hole to the size of the electrode may be limited to a range of less than ½. This is because when the size of the hole exceeds ½ of the size of the electrode, the function of guiding the droplet by electrowetting may be excessively weakened.

Meanwhile, even when the sizes of electrodes are the same, the size of holes may be larger in electrodes of interest where optical observation of droplets is important. This will be described in detail with reference to FIG. 17.

Referring to FIG. 17, a plurality of electrodes 251, 252, 253, 254, 255, 256 having the same size are illustrated. Among them, it is assumed that a first electrode 251 and a sixth electrode 256 are electrodes of interest where optical observation of droplets is important. For example, it is assumed that a droplet in which a first reaction has occurred is guided to the first electrode 251, and the droplet undergoes a second reaction while passing through the second to fifth electrodes 252, 253, 254, 255 and emits a reaction result as light on the sixth electrode 256.

In this case, it is preferable make the size of holes relatively large in the first electrode 251 where a first reaction result of the droplet is observed and the sixth electrode 256 where a second reaction result is observed in order to facilitate optical observation. On the other hand, in the second to fifth electrodes 252, 253, 254, 255 where optical observation of the droplet is not very important, it is preferable to reduce the size of holes and increase the area of peripheral portions in order to facilitate guidance of droplets by electrowetting.

Therefore, even when the electrodes have the same size, the size of the holes may be formed relatively larger in the electrodes of interest where optical observation of droplets is important.

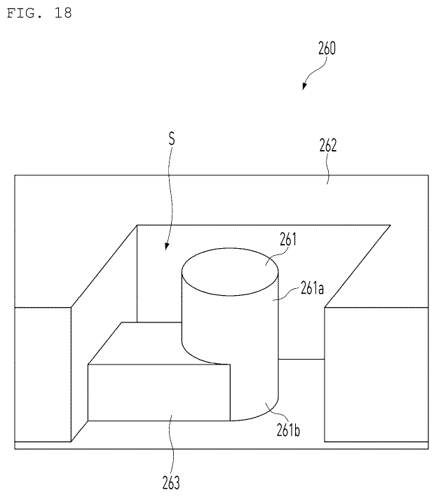

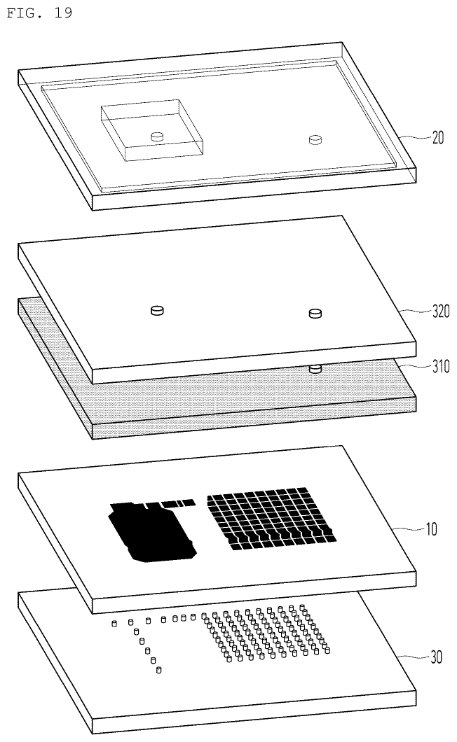

Meanwhile, when the hole of the electrode is formed of a transparent insulator, the hole may be formed in a form integrated into the base plate. This will be described in detail with reference to FIG. 18.

Referring to FIG. 18, illustrated is an exemplary form 260 of a base plate and a hole according to an embodiment of the present disclosure.

A hole 261 includes a transparent insulator, and a lower portion 261b of the hole 261 is connected to a base plate 262 through a connecting portion 263. An upper portion 261a of the hole 261 is separated and spaced apart from the base plate 262 at a predetermined distance. A conductive polymer is filled between the hole 261 and the base plate 262 to form a peripheral portion of an electrode.

In one embodiment, the hole 261 may be formed together with the base plate 262 by injection molding. For example, the hole 261 and the base plate 262 may be formed simultaneously by injecting the transparent insulator using an injection gate into a mold in which a space corresponding to the hole 261 and the base plate 262 is formed. Accordingly, since the hole and the base plate are formed in a single process, the overall process may be simplified and the manufacturing cost of the droplet actuator may be reduced.

With the electrode structure according to the present disclosure which has been described through the above embodiments, it is possible to optically observe a droplet and light emitted from the droplet through the hole formed inside the electrode.

Hereinafter, described will be an embodiment in which the droplet actuator according to the present disclosure is provided with a plurality of parallel electrodes to enhance an electrowetting force.

FIG. 19 is an exploded perspective view illustrating an exemplary form of a droplet actuator having a parallel electrode structure according to an embodiment of the present disclosure.

Similar to the example of FIG. 1, the example of FIG. 19 also includes an electrode plate 10, a housing 20, and a substrate 30. However, the example of FIG. 19 further includes another electrode layer 310 and another substrate 320 between the electrode plate 10 and the housing 20.

The housing 20 may contain a fluid. At this time, the housing 20 may include a fluid receptacle for containing the fluid. The configuration and function of the housing 20 according to the present embodiment remain substantially the same as those of the housing 20 described above with reference to FIGS. 1 to 8, so a detailed description thereof is omitted to avoid duplicated explanation.

The electrode plate 10 may induce polarization within a droplet through an electrowetting signal to move the droplet distributed from the fluid contained in the housing 20 to the position of a target electrode. At this time, the electrode plate 10 may include at least one electrode for conducting the electrowetting signal. The configuration and function of the electrode plate 10 according to the present embodiment remain substantially the same as those of the electrode plate 10 described above with reference to FIGS. 1 to 8, so a detailed description thereof is omitted to avoid duplicated explanation.

The substrate 30 may transmit the electrowetting signal to the electrode plate 10. For example, the substrate 30 may be any one of a glass substrate, a silicon substrate, a printed circuit board (PCB), and a thin film transistor (TFT). The configuration and function of the substrate 30 according to the present embodiment remain substantially the same as those of the substrate 30 described above with reference to FIGS. 1 to 8, so a detailed description thereof is omitted to avoid duplicated explanation.

The other electrode layer 310 is placed at a position facing the electrode plate 10 and spaced apart from the electrode plate 10. A droplet is located between the other electrode layer 310 and the electrode plate 10. When the electrode plate 10 applies the electrowetting signal to the droplet through an electrode array formed therein, the other electrode layer 310 applies a predetermined reference potential to the droplet.

Accordingly, compared to the previous examples of FIGS. 1 to 9 where the droplet is guided only by the lower electrode plate 10, polarization within the droplet may occur more effectively, thus improving the electrowetting force and enabling the droplet to be guided more effectively in a desired direction.

In one embodiment, the predetermined reference potential may be a ground potential, i.e., 0 V.

The other substrate 320 is located on top of the other electrode layer 310, and provides an electrical path for applying the predetermined reference potential to the other electrode layer 310.

For example, the other substrate 320 may be any one of a glass substrate, a silicon substrate, a printed circuit board (PCB), and a thin film transistor (TFT). However, the scope of the present disclosure is not limited to these examples, and any known technology having a structure capable of transmitting a reference potential to the other electrode layer 310 may be applied to the present disclosure.

Meanwhile, the other electrode layer 310 may be formed in various shapes.

In one embodiment, the other electrode layer 310 may be formed by coating, depositing, attaching, or bonding a conductive polymer, indium tin oxide (ITO), or metal to the other substrate 120.

In another embodiment, the other electrode layer 310 may be formed in the same manner as the electrode is formed in the electrode plate 10, i.e., by providing a separate base plate and forming the other electrode layer 310 on or inside the base plate or by forming the other electrode layer through the interior of the base plate.

In this case, the separate base plate may be formed by injecting an insulator into a partial space of a mold using an injection gate, and the other electrode layer 310 may be formed by injecting a conductive polymer into another space of the mold using another injection gate that is distinct from the injection gate.

In one embodiment, the insulator may include at least one of polycarbonate (PC), poly methyl methacrylate (PMMA), cyclic olefin polymer (COP), cyclic olefin copolymer (COC), polyethylene terephthalate (PET), polyimide (PI), polyethylene (PE), acrylic, acrylonitrile butadiene styrene (ABS), polyvinylidene fluoride (PVDF), polytetrafluoroethylene (PTFE), polystyrene (PS), polypropylene (PP), and polyvinyl chloride (PVC). In addition, it is noted that any known composition including a thermoplastic resin for conducting an electric signal may be applied to the present disclosure for the manufacture of the insulator.

In one embodiment, the conductive polymer may include a mixture of a polymer and a conductive material. At this time, the mixture may include at least one of conductive materials, such as carbon nanotubes, graphene, and carbon fiber, along with the polymer. In addition, it is noted that any known mixture for conducting an electric signal may be applied to the present disclosure for the manufacture of the electrode.

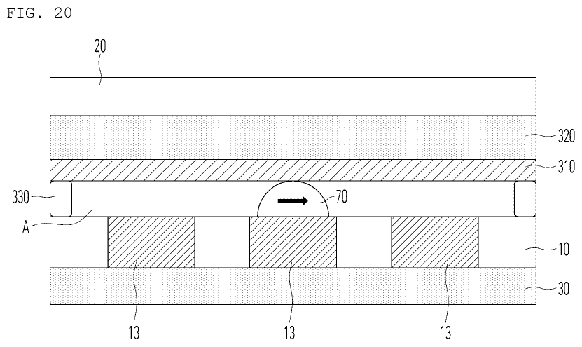

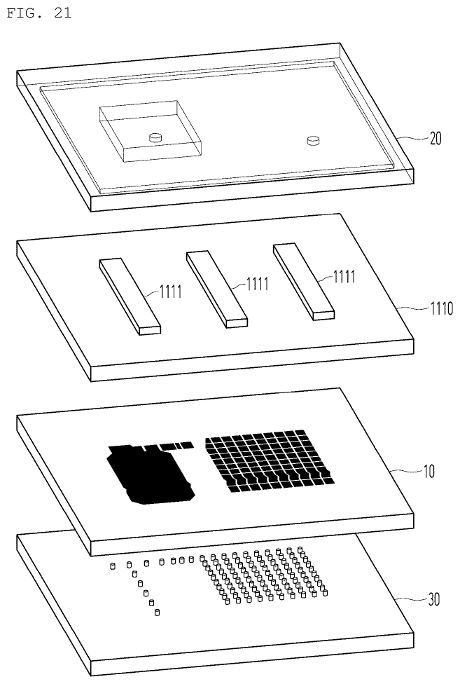

FIG. 20 illustrates a sectional structure of the droplet actuator illustrated in FIG. 19 and an electrowetting operation thereof. In the description with reference to FIG. 20, for convenience of explanation, the electrode array formed inside the electrode plate 10 is referred to as a first electrode, the substrate 30 is referred to as a lower substrate, and the other electrode layer 310 and the other substrate 320 between the electrode plate 10 and the housing 20 are referred to as a second electrode and an upper substrate, respectively. The description will be given below with reference to the drawings.

FIG. 20 is a sectional view illustrating the droplet actuator with a stacked structure illustrated in FIG. 19.

Referring to FIG. 20, illustrated is the structure of the droplet actuator in which the lower substrate 30, the electrode plate 10 having the first electrode 13 formed therein, the second electrode 310, the upper substrate 320, and the housing 20 are stacked.

A spacer 330 is interposed between the first electrode 13 and the second electrode 310 to maintain a gap between the first electrode 13 and the second electrode 310, thereby creating a space A through which a droplet 70 moves.

In one embodiment, a dielectric layer (not illustrated) may be additionally stacked between the droplet 70 and the first electrode 13 or between the droplet 70 and the second electrode 310, and a hydrophobic coating may be applied to a surface of the first electrode 13 or the second electrode 110.

In the droplet actuator illustrated in FIG. 20, in order to guide the droplet 70 in a specific direction, an electrowetting signal for moving the droplet 70 in the specific direction is applied to the first electrode 13, and a reference potential is applied to the second electrode 310. As a result, polarization due to an electric field occurs within the droplet 70. This causes a change in the surface tension and shape of the droplet 70, allowing the droplet to move in a desired direction.

At this time, since the droplet actuator illustrated in FIG. 20 is provided with the second electrode 310 to which the reference potential is applied, a stronger electric field is formed compared to the droplet actuator illustrated in FIGS. 1 to 8, and thus the electrowetting force for moving the droplet 70 also becomes stronger.

With the structure of the diagnostic device which has been described through the above embodiments, it is possible to enhance the electrowetting force by the lower electrode to which the electrowetting signal is applied and the upper electrode having the reference potential, thereby facilitating guidance of the droplet.

Hereinafter, described will be an embodiment in which the droplet actuator according to the present disclosure has a temperature control function for a local area and a cleaning function within a droplet.

FIG. 21 is an exploded perspective view illustrating an exemplary form of a droplet actuator having a temperature controller according to an embodiment of the present disclosure.

Similar to the example of FIG. 1, the example of FIG. 21 also includes an electrode plate 10, a housing 20, and a substrate 30. However, the example of FIG. 21 further includes another substrate 1110 between the electrode plate 10 and the housing 20.

The housing 20 may contain a fluid. At this time, the housing 20 may include a fluid receptacle for containing the fluid. The configuration and function of the housing 20 according to the present embodiment remain substantially the same as those of the housing 20 described above with reference to FIGS. 1 to 8, so a detailed description thereof is omitted to avoid duplicated explanation.

The electrode plate 10 may induce polarization within a droplet through an electrowetting signal to move the droplet distributed from the fluid contained in the housing 20 to the position of a target electrode. At this time, the electrode plate 10 may include at least one electrode for conducting the electrowetting signal. The configuration and function of the electrode plate 10 according to the present embodiment remain substantially the same as those of the electrode plate 10 described above with reference to FIGS. 1 to 8, so a detailed description thereof is omitted to avoid duplicated explanation.

The substrate 30 may transmit the electrowetting signal to the electrode plate 10. For example, the substrate 30 may be any one of a glass substrate, a silicon substrate, a printed circuit board (PCB), and a thin film transistor (TFT). The configuration and function of the substrate 30 according to the present embodiment remain substantially the same as those of the substrate 30 described above with reference to FIGS. 1 to 8, so a detailed description thereof is omitted to avoid duplicated explanation.

The other substrate 1110 is located on top of the electrode plate 10 and has one or more temperature controllers 1111. The temperature controllers 1111 may be heaters for locally heating a portion of the electrode plate 10, but the scope of the present disclosure is not limited thereto. For example, the temperature controllers 1111 may be coolers for locally cooling a portion of the electrode plate 10.

In one embodiment, when the temperature controller 1111 are heaters, the temperature controllers 1111 may include one or more resistors that generate heat when current flows.

In one embodiment, when the temperature controller 1111 are heaters, the temperature controllers may include a magnetic induction type heating device.

In one embodiment, the other substrate 1110 may be any one of a glass substrate, a silicon substrate, a printed circuit board (PCB), and a thin film transistor (TFT). However, the scope of the present disclosure is not limited to these examples, and any known technology having a structure in which the temperature controllers 1111 can be embedded may be applied to the present disclosure.

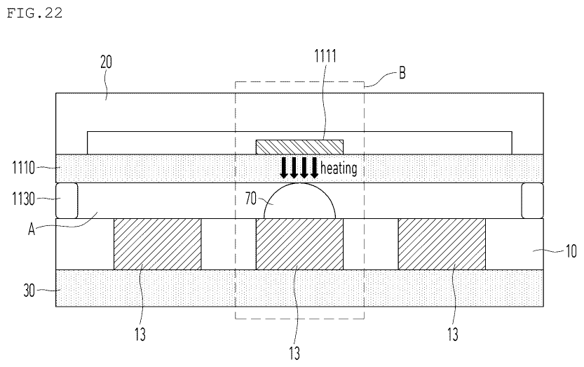

FIG. 22 is a sectional view illustrating a detailed structure of the droplet actuator illustrated in FIG. 21 and a temperature control method using the same.

FIG. 22 illustrates the cross-sectional structure of the droplet actuator illustrated in FIG. 21 and a temperature control operation thereof. In the description with reference to FIG. 22, for clarity of terminology, the substrate 30 located relatively lower is referred to as a lower substrate, and the other substrate 1110 located relatively upper is referred to as an upper substrate.

Referring to FIG. 22, illustrated is the structure of the droplet actuator in which the lower substrate 30, the electrode plate 10 having an electrode 13 formed therein, the upper substrate 1110, and the housing 20 are stacked.

A spacer 1130 is interposed between the electrode plate 10 and the upper substrate 1110 to maintain a gap between the electrode plate 10 and the upper substrate 1110, thereby creating a space A through which a droplet 70 moves.

One or more temperature controllers 1111 are arranged on the upper substrate 1110. The temperature controllers 1111 are a configuration for controlling the temperature of the droplet 70 located in a heat area B, and may be, for example, heaters for selectively locally heating the heat area B or coolers for locally cooling the heat area B. The heat area B includes at least a portion of the electrode plate 10.

When the temperature controller 1111 are heaters, the temperature controllers 1111 are heated in response to a control signal transmitted through the upper substrate 1110, and heat is transferred from the temperature controllers 1111 to the heat area B. As a result, the droplet 70 located in the heat area B is also heated.

This temperature control function is necessary to enable a specific process to be performed under predetermined temperature conditions. For example, the temperature control function may be required for DNA denaturation for droplet analysis. Specifically, the temperature controllers 1111 may be controlled to heat the heat area B to a temperature suitable for denaturing DNA within the droplet 70, or to heat the heat area B to a temperature effective for performing other reaction steps, such as annealing of a primer to a template strand DNA or extension of a primer by a DNA polymerase.

According to the example of FIG. 22, by providing the temperature controllers 1111, it is possible for the droplet actuator to satisfy the optimal temperature conditions required for droplet analysis and diagnosis.

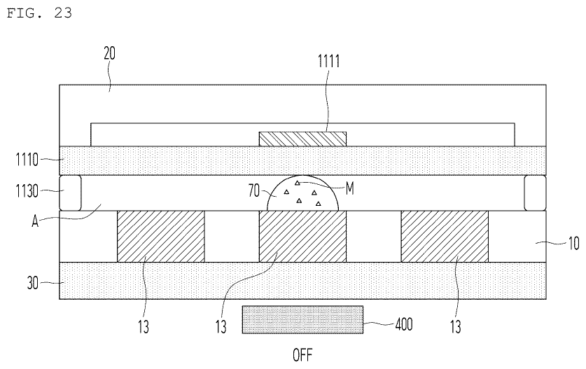

FIGS. 23 to 25 are views illustrating a droplet actuator having a cleaning function using magnetic force and a cleaning method using the same.

Here, the term “cleaning” means that some substances contained in a droplet 70 are separated and removed to the outside of the droplet 70.

Referring to FIG. 23, a plurality of magnetic beads M are included within the droplet 70. In addition, a magnetic force provider 400 is provided inside or outside the droplet actuator to guide or fix the magnetic beads M to a specific position or direction. The magnetic force provider 400 may include a permanent magnet or an electromagnet.

The magnetic force provider 400 may be used to remove some substances from the droplet 70 prior to droplet analysis. At this time, the substances to be removed may include a contaminant contained in the droplet 70, an oversupplied reagent, or a substance to be separated from the droplet 70 for separate analysis.

First, the magnetic beads M are included within the droplet 70. At this time, including the magnetic beads M within the droplet 70 may be achieved in the following manner. The magnetic beads may be originally contained in the droplet 70, may be injected into the droplet 70 at a specific section inside the droplet actuator during the process of guiding the droplet 70 to its current position, or may be placed in advance at a specific position inside the droplet actuator and then naturally mixed with the droplet 70 as the droplet 70 moves to the corresponding position.

In FIG. 23, the cleaning function is not yet operated. Therefore, the magnetic force provider 400 is kept in an OFF state, and a magnetic force does not act on the droplet 70. At this time, the magnetic beads M react to a specific substance in the droplet 70 and bind to the substance.

In one embodiment, the magnetic force provider 400 may be a configuration provided inside the droplet actuator, or may be a configuration provided in a separate tester outside the droplet actuator.

Meanwhile, in the present embodiment, the magnetic force provider 400 is exemplified as being located below the lower substrate 30, but the scope of the present disclosure is not limited thereto. For example, the magnetic force provider 400 may be located between the lower substrate 30 and the electrode plate 10, located on an upper or lower portion of the upper substrate 1110, or located on an upper portion or side surface of the droplet actuator.

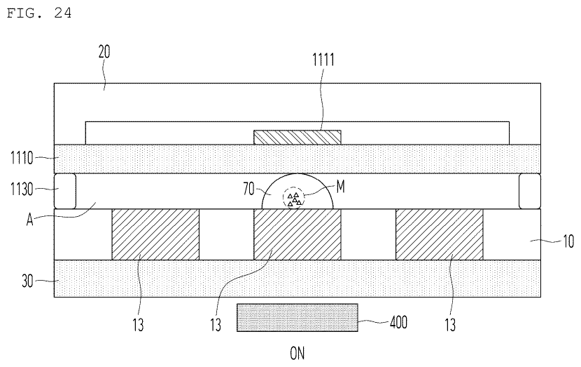

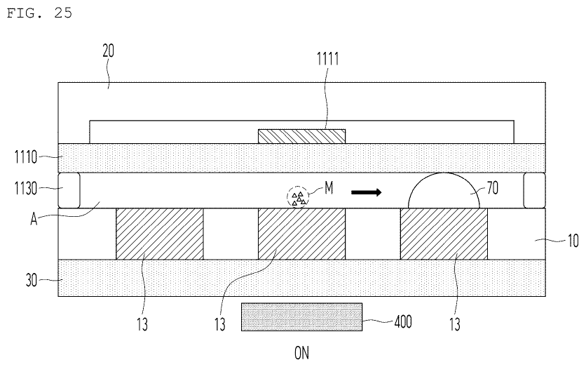

Next, a method of operating the cleaning function will be described with reference to FIGS. 24 and 25.

In FIG. 24, the magnetic force provider 400 is switched to an ON state, and the magnetic force is applied from the magnetic force provider 400 to the droplet 70. The magnetic force applied to the droplet 70 pulls the magnetic beads M within the droplet 70 in the direction in which the magnetic force provider 400 is located. At this time, the substance bound to the magnetic beads M is also pulled in the direction in which the magnetic force provider 400 is located.

Referring to FIG. 25, while the magnetic beads M and the substance bound thereto are attracted in the direction in which the magnetic force provider 400 is located, the droplet 70 moves to a different location in response to an electrowetting signal applied to the electrode 13. At this time, since the magnetic beads M are pulled downward by the magnetic force, and they do not follow the droplet 70 but remain in their original positions separated from the droplet 70. At this time, the substance bound to the magnetic beads M also remains in its original position together with the magnetic beads M.

In this manner, the specific substance, i.e., the substance bound to the magnetic beads M, are separated and removed from the droplet 70.

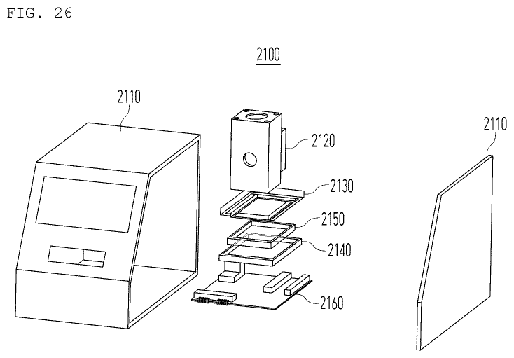

FIG. 26 is a view exemplarily illustrating the configuration of a signal reader that reads test results of a sample of a droplet actuator.

Referring to FIG. 26, the signal reader 2100 includes a housing 2110, an optical unit 2120, an upper socket 2130, a lower socket 2140, and a main board 2160. The droplet actuator 2150 described above with reference to FIGS. 1 to 25 may be inserted in the form of a cartridge between the upper socket 2130 and the lower socket 2140. In one embodiment, the signal reader 2100 may further include a screen (not illustrated).

The signal reader 2100 generates and controls an electrowetting signal applied to the droplet actuator 2150. The sample within the droplet actuator 2150 may be sensed by an optical method, such as colorimetry, fluorometry, or imaging, via the signal reader 2100. Alternatively, the sample within the droplet actuator 2150 may be sensed electrochemically or electromagnetically via the signal reader 2100.

The optical unit 2120 provides an optical means for sensing the sample within the droplet actuator 2150.

The upper socket 2130 and the lower socket 2140 provide a mechanical means for receiving the droplet actuator 2150.

The main board 2160 performs electrical or electronic control, such as temperature control, magnetic field control, and droplet position detection, for the droplet actuator 2150.

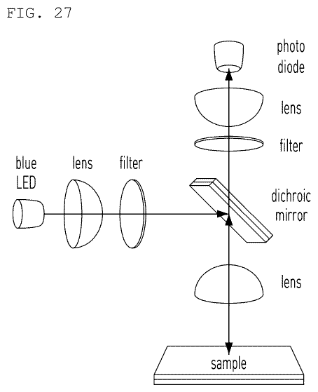

FIG. 27 is a view exemplarily illustrating the configuration of the optical unit illustrated in FIG. 26.

Referring to FIG. 27, the optical unit includes a blue LED, a photodiode, a dichroic mirror, one or more lenses, and one or more filters.

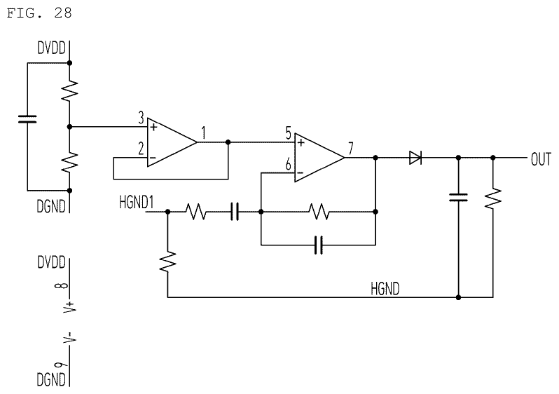

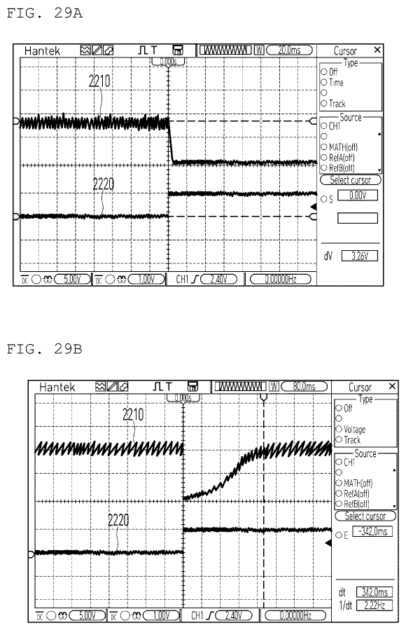

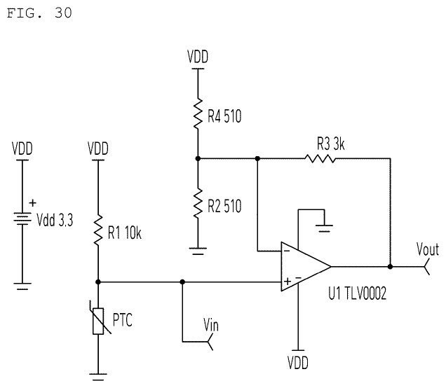

FIGS. 28 to 31 are views more specifically illustrating a droplet position detection function of the main board illustrated in FIG. 26.

FIG. 28 illustrates an exemplary configuration of a droplet position detection circuit provided on the main board. The main board may include a droplet position detection circuit, such as that illustrated in FIG. 28, for determining the position of a droplet on an electrowetting electrode within the droplet actuator. The main board may detect a current position of the droplet by using the droplet position detection circuit to sense a change in resistance or capacitance according to the movement of the droplet or by using an image sensor.

FIG. 29 illustrates an exemplary form of a droplet position detection result using the droplet position detection circuit.

FIG. 29A illustrates a case where droplet movement in response to an electrowetting signal was unsuccessful. In a section where a droplet movement signal 2220 increased to a high state, a droplet sensing signal 2210 was still in a low state. This means that droplet movement did not actually occur even though the electrowetting signal was applied.

FIG. 29B illustrates a case where droplet movement in response to an electrowetting signal was successful. In a section where the droplet movement signal 2220 increased to a high state, the droplet sensing signal 2210 also changed to a high state. This means that droplet movement actually occurred by the application of the electrowetting signal.

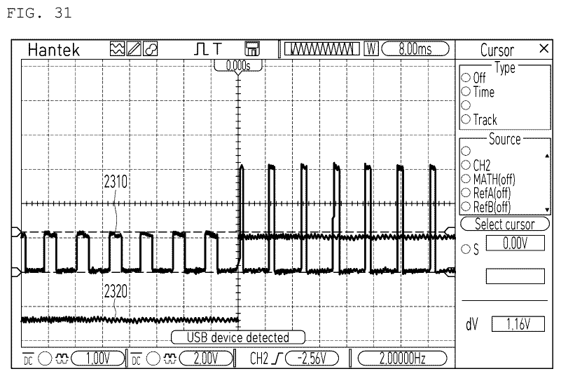

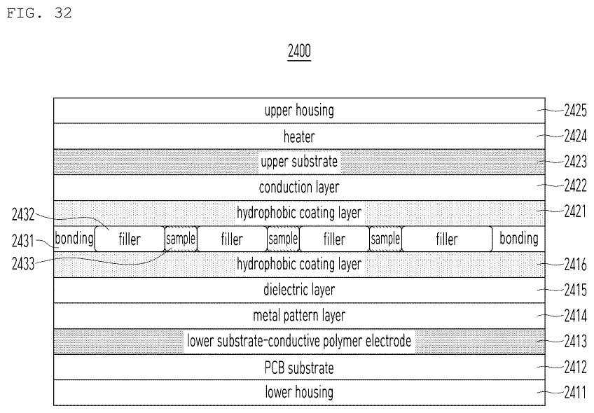

FIGS. 30 and 31 are views more specifically illustrating a temperature control function of the main board illustrated in FIG. 26.

FIG. 30 illustrates an exemplary configuration of a temperature control circuit provided on the main board. The motherboard may include a temperature control circuit, such as that illustrated in FIG. 30, for controlling the temperature of a temperature controller (e.g., a heater) of the droplet actuator. The main board controls the temperature through the temperature control circuit by sensing a change in resistance value according to the temperature within the diagnostic device or a value of other temperature sensors.

FIG. 31 illustrates an exemplary configuration for controlling the output of a plurality of temperature sensing circuits with a single temperature controller.

It can be confirmed that a sensor value 2310 input to the temperature controller changed to a selected sensor output as a temperature sensor selection signal 2320 changed.

FIG. 32 is a view illustrating a new stacked structure of a droplet actuator according to another embodiment of the present disclosure. Referring to FIG. 32, the droplet actuator 2400 having a stacked structure according to the present embodiment includes a lower plate where a lower housing 2411, a PCB substrate 2412, a lower substrate 2413, a metal pattern layer 2414, a dielectric layer 2415, and a hydrophobic coating layer 2416 are sequentially stacked, and an upper plate where a hydrophobic coating layer 2421, a conduction layer 2422, an upper substrate 2423, a heater 2424, and an upper housing 2425 are sequentially stacked. The upper plate and the lower plate may be spaced apart from each other so that a space is formed therebetween to receive a droplet therein.

The space may have a bonding 2431 that joins the upper plate and the lower plate, at least one filler 2432, and/or at least one sample 2433.

In one embodiment, the PCB substrate 2412 may function as an interconnect layer.

In one embodiment, a conductive polymer electrode may be formed on the lower substrate 2413.

In one embodiment, the conduction layer 2422 may include ITO, a metal, or a conductive polymer.

The dielectric layer 2415 is a configuration for providing electrical insulation between the conductive polymer electrode or a conduction layer and the droplet, and may include an insulating polymer or a material such as parylene-C, SiO₂, or Si₃N₄.

The hydrophobic coating layer 2416, 2421 is a layer for hydrophobic coating treatment on a surface of the metal pattern layer 2414 or the conduction layer 2422. The hydrophobic coating layer 2416, 2421 may be coated using a method such as spin coating, dip coating, spray coating, or plasma coating using HMDS, a fluorine solution, or gas.

The filler 2432 is a fluid material filled between the upper plate and the lower plate to facilitate the movement of the droplet and prevent evaporation of the droplet and bubble generation at high temperatures. The filler 2432 may be a non-polar solvent that does not dissolve in water, or a mixture thereof with a surfactant or lubricant.

In one embodiment, siloxane or silicone oil may be used as the filler 2432.

Meanwhile, a spacer may be placed between the upper plate and the lower plate to maintain a gap between the upper plate and the lower plate, thereby creating a space through which the droplet moves. At this time, the upper plate and the lower plate may be bonded using a method such as an adhesive, ultrasonic welding, or laser welding.

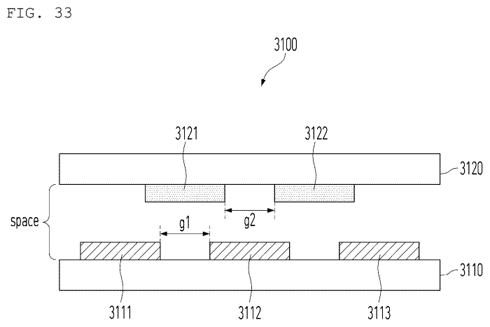

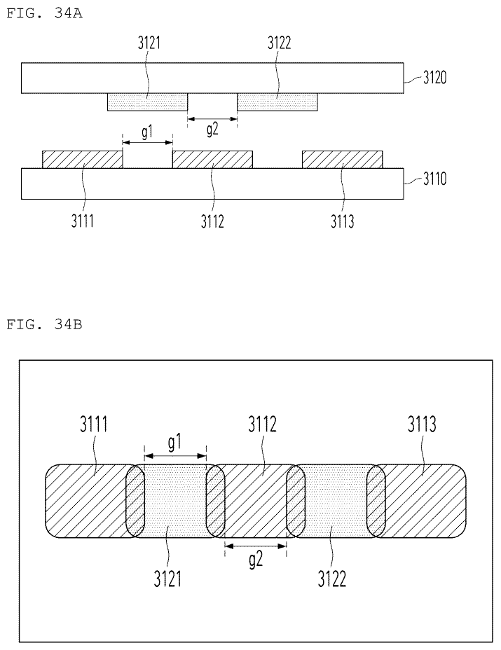

FIG. 33 is a view illustrating a droplet actuator having a vertical electrode structure according to an embodiment of the present disclosure. Referring to FIG. 33, the droplet actuator 3100 according to the present embodiment includes a lower substrate 3110 including a plurality of electrodes 3111, 3112, 3113, and an upper substrate 3120 including a plurality of other electrodes 3121, 3122. The upper substrate 3120 and the lower substrate 3110 are spaced apart from each other so that a space is formed or defined therebetween to receive a droplet therein and to allow the droplet to move therethrough.

The plurality of electrodes 3111, 3112, 3113 serve as electrowetting electrodes for handling the droplet, and a gap is formed between adjacent electrodes so that the adjacent electrodes are spaced apart from each other with the gap therebetween. For example, among the plurality of electrodes 3111, 3112, 3113, a first electrode 3111 and a third electrode 3112, which are adjacent to each other, are spaced apart from each other with a first gap g1 therebetween.

The plurality of other electrodes 3121, 3122 also serve as electrowetting electrodes for handling the droplet, and a gap is formed between adjacent electrodes. For example, among the plurality of other electrodes 3121, 3122, a second electrode 3121 and a fourth electrode 3122, which are adjacent to each other, are spaced apart from each other with a second gap g2 therebetween.

At this time, the plurality of electrodes 3111, 3112, 3113 formed on the lower substrate 3110 and the plurality of other electrodes 3121, 3122 formed on the upper substrate 3120 are arranged to be offset from each other. For example, the second electrode 3121 of the upper substrate 3120 may be disposed at a position facing the first gap g1 between the first electrode 3111 and the third electrode 3112 of the lower substrate 3110 so as to be offset from the first electrode 3111 and the third electrode 3112. Similarly, the third electrode 3112 of the lower substrate 3110 may be disposed at a position facing the second gap g2 between the second electrode 3121 and the fourth electrode 3122 of the upper substrate 3120 so as to be offset from the second electrode 3121 and the fourth electrode 3122.

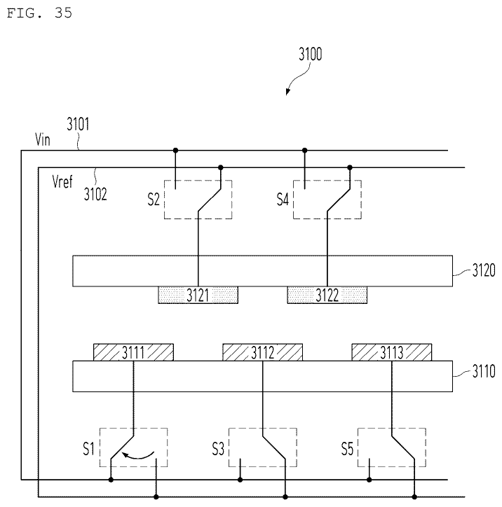

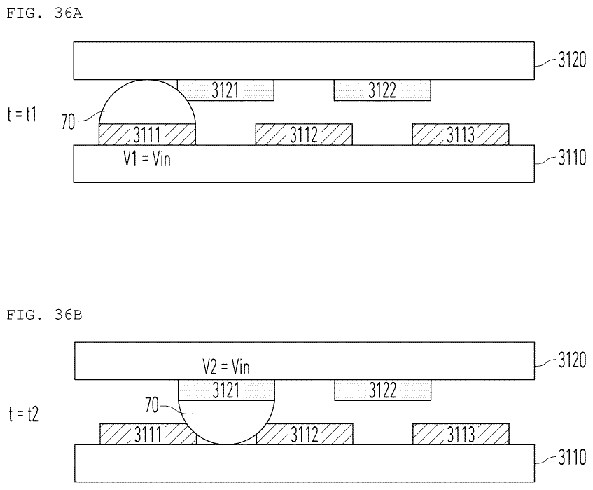

Meanwhile, an electrode arrangement structure illustrated in FIG. 33 will be described in more detail with reference to FIG. 34. FIG. 34A is a side view illustrating the droplet actuator, and FIG. 34B is a plan view illustrating the upper substrate 3120 of the droplet actuator when viewed from above.

FIG. 34A is provided for comparison with FIG. 34B, and the structure and technical features illustrated therein remain the same as those illustrated in FIG. 33.

Referring to FIG. 34B, the arrangement relationship between the electrodes 3121, 3122 of the upper substrate 3120 and the electrodes 3111, 3112, 3113 of the lower substrate 3110 is clearly illustrated in the plan view.

In FIG. 34B, each of the electrodes 3121, 3122 of the upper substrate 3120 is disposed to at least partially overlap with two adjacent electrodes of the lower substrate 3110 and the gap therebetween when viewed from above.

For example, when viewed from above the upper substrate 3120, the second electrode 3121 at least partially overlaps with the first electrode 3111 and the third electrode 3112 adjacent thereto. In addition, at the same time, the second electrode 3121 at least partially overlaps with the first gap g1 between the first electrode 3111 and the third electrode 3112 when viewed from above the upper substrate 3120. A similar arrangement structure is applied to the other electrode 3122 of the upper substrate 3120.

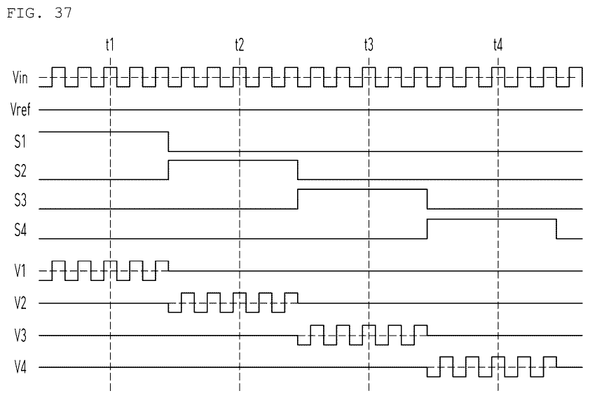

According to such an electrode arrangement structure, when an operating signal (i.e., an electrowetting signal) is applied to move a droplet, the droplet may be moved while being alternately brought into close contact with the upper substrate 3120 and the lower substrate 3110, thereby ensuring a more smooth movement of the droplet between the electrodes of the upper substrate 3120 and the electrodes of the lower substrate 3110. This will be described later in more detail with reference to FIGS. 36 and 37.

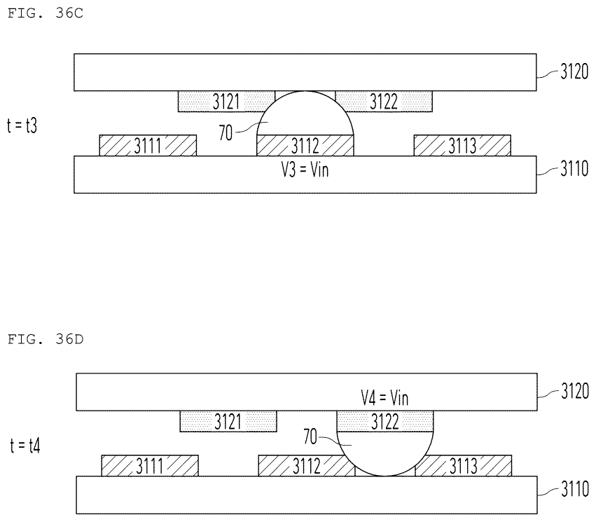

FIG. 35 is a view illustrating a switch circuit of the droplet actuator. The switch circuit illustrated FIG. 35 is configuration for selectively applying an operating signal to each of the electrodes 3111, 3112, 3113, 3121, 3122 of the droplet actuator 3100. The switch circuit according to the present embodiment includes one or more signal lines 3101, 3102 and a plurality of switches S1, S2, S3, S4, S5.

Among the one or more signal lines 3101, 3102, a first signal line 3101 is a signal line to which an operating signal Vin (i.e., an electrowetting signal) is provided. Among the one or more signal lines 3101, 3102, a second signal line 3102 is a signal line to which a reference potential Vref (e.g., a ground potential) is applied. The one or more signal lines 3101, 3102 may be electrically connected to each of the electrodes 3111, 3112, 3113, 3121, 3122 of the droplet actuator 3100 by the switches S1, S2, S3, S4, S5.

The plurality of switches S1, S2, S3, S4, S5 are switching elements for selectively connecting each of the electrodes 3111, 3112, 3113, 3121, 3122 of the droplet actuator 3100 to one of the signal lines 3101, 3102. Each of the plurality of switches S1, S2, S3, S4, S5 may be controlled independently of each other and may be matched one-to-one with each of the electrodes 3111, 3112, 3113, 3121, 3122.

In one embodiment, the control of the plurality of switches S1, S2, S3, S4, S5 may be performed by a controller (not illustrated) provided in the droplet actuator 3100.

Alternatively, in another embodiment, the control of the plurality of switches S1, S2, S3, S4, S5 may be performed by a controller (not illustrated) provided in a test device outside the droplet actuator 3100. In this case, each element 3101, 3102, S1, S2, S3, S4, S5 constituting the switch circuit may be a configuration included in the external tester device rather than the droplet actuator 3100.

In one embodiment, the plurality of switches S1, S2, S3, S4, S5 may be controlled so that the operating signal Vin is sequentially provided to each of the electrodes 3111, 3112, 3113, 3121, 3122. At this time, the plurality of switches S1, S2, S3, S4, S5 may be controlled so that the reference potential Vref is applied to electrodes to which the operating signal Vin is not provided.

This will be described with reference to FIGS. 36 and 37 for clear understanding.

FIG. 36 is a view illustrating the operation of the electrowetting electrodes over time and the movement of the droplet thereby, and FIG. 37 is a timing view illustrating the operation of the switch circuit and the potential state of the electrodes for each time interval. The description will be given below with reference to the drawings.

First, at a time t1, the first switch S1 is controlled (S1=High) so that the operating signal Vin is applied to the first electrode 3111, thereby causing the droplet to be positioned on the first electrode 3111. At this time, the remaining switches S2, S3, S4, S5 are controlled so that the reference potential Vref is applied to the remaining electrodes 3112, 3113, 3121, 3122 (S2, S3, S4, S5=Low).

Then, at a time t2, the second switch S2 is controlled so that the operating signal Vin is applied to the second electrode 3121 to move the droplet from the first electrode 3111 to the second electrode 3121 (S2=High). At the same time, the remaining switches S1, S3, S4, S5 are controlled so that the reference potential Vref is applied to the remaining electrodes 3111, 3112, 3113, 3122 (S1, S3, S4, S5=Low).

Then, at a time t3, the third switch S3 is controlled so that the operating signal Vin is applied to the third electrode 3112 to move the droplet from the second electrode 3121 to the third electrode 3112 (S3=High). At the same time, the remaining switches S1, S2, S4, S5 are controlled so that the reference potential Vref is applied to the remaining electrodes 3111, 3113 3121, 3122 (S1, S2, S4, S5=Low).

Then, at a time t4, the fourth switch S4 is controlled so that the operating signal Vin is applied to the fourth electrode 3122 to move the droplet from the third electrode 3112 to the fourth electrode 3122 (S4=High). At the same time, the remaining switches S1, S2, S3, S5 are controlled so that the reference potential Vref is applied to the remaining electrodes 3111, 3112, 3113, 3121 (S1, S2, S3, S5=Low).

According to the operation of the droplet actuator 3100 described with reference to FIGS. 36 and 37, as the operating signal Vin is sequentially applied to the first electrode 3111, the second electrode 3121, the third electrode 3112, and the fourth electrode 3122, the droplet moves sequentially to a surface of the first electrode 3111, a surface of the second electrode 3121, a surface of the third electrode 3112, and a surface of the fourth electrode 3122.

This has the following advantageous technical effects. A conventional droplet actuator has electrowetting electrodes only on a lower substrate. For this reason, when the lower substrate has a surface slightly roughly processed, there is a problem in that when a droplet moves through a gap between adjacent electrodes during droplet manipulation, the droplet cannot pass through the gap due to friction with a gap surface and stops in the middle of its movement.

On the contrary, according to the droplet actuator according to the present embodiment, when a droplet passes through a gap between adjacent electrodes, the droplet moves to other electrodes formed on an opposing substrate while being in close contact with it, thereby reducing friction between the droplet and a gap surface. This enables the movement of the droplet between the electrodes to be performed smoothly even when a substrate surface is slightly roughly processed.

In addition, since the substrate surface does not need to be processed very smoothly during substrate manufacturing, the manufacturing process of the droplet actuator may be simplified and the overall production cost may be reduced.

In addition, unlike the case where electrodes are formed only on the lower substrate, even when the gap between adjacent electrodes is not very close, the droplet is allowed to move to other electrodes formed on the opposing substrate. Therefore, the droplet actuator may not be affected in its performance even when manufactured by a process with low precision, thereby reducing the production cost.

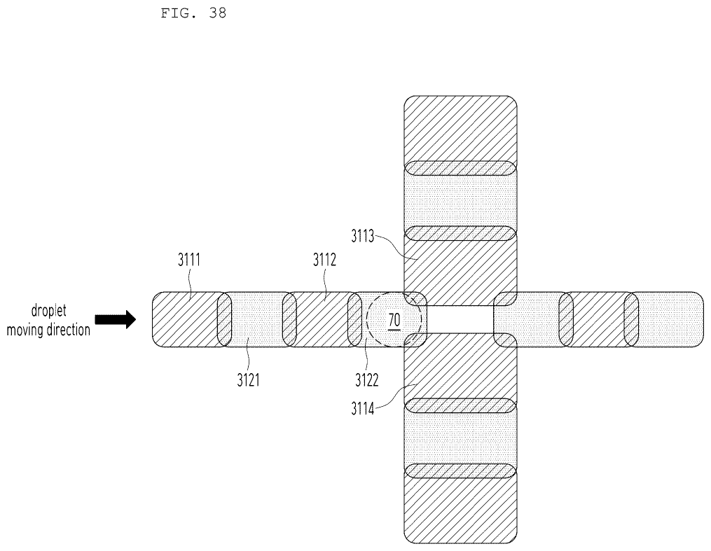

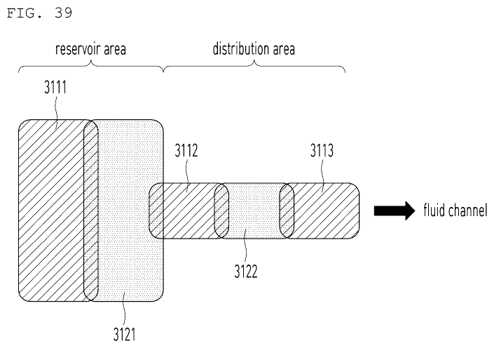

FIGS. 38 and 39 are views illustrating exemplary electrowetting electrode arrangements of the droplet actuator illustrated in FIG. 33.

FIG. 38 is a plan view illustrating the electrowetting electrode arrangement in the form of a crossroads where a path of the droplet branches, when viewed from above the upper substrate of the droplet actuator.

Referring to FIG. 38, the first electrode 3111, the second electrode 3121, the third electrode 3112, and the fourth electrode 3122 are sequentially arranged in a droplet moving direction. The first electrode 3111 and the third electrode 3112 may be electrodes formed on the lower substrate, and the second electrode 3121 and the fourth electrode 3122 may be electrodes formed on the upper substrate.

The fifth electrode 3113 and the sixth electrode 3114 are arranged next to the fourth electrode 3122. The fifth electrode 3113 and the sixth electrode 3114 are electrodes formed on the lower substrate and may be electrodes spaced apart from the third electrode 3112 with a gap therebetween. The fifth electrode 3113 and the sixth electrode 3114 may also be spaced apart from each other with a gap therebetween.

In one embodiment, the fourth electrode 3122 may at least partially overlap with the third electrode 3112, the fifth electrode 3113, and the sixth electrode 3114 when viewed from above the upper substrate (i.e., in the plan view of FIG. 38).

In the electrode arrangement illustrated in FIG. 38, the droplet 70 may move from the first electrode 3111 to the surface of the fourth electrode 3122 through the second electrode 3121 and the third electrode 3112 in response to sequential application of the operating signal to each of the electrodes 3111, 3121, 3112, 3122. In addition, in response to selective application of the operating signal to the fifth electrode 3113 and/or the sixth electrode 3114, the droplet (i) may move over the fifth electrode 3113, (ii) may move over the sixth electrode 3114, or (iii) may be split or spread over the fifth electrode 3113 and the sixth electrode 3114.

For example, after the droplet 70 moves to the surface of the fourth electrode 3122, when the operating signal is applied to the fifth electrode 3113 and the reference potential is applied to the remaining electrodes 3111, 3121, 3112, 3122, 3114, the droplet 70 may move over the fifth electrode 3113. Alternatively, after the droplet 70 moves to the surface of the fourth electrode 3122, when the operating signal is applied to the sixth electrode 3114 and the reference potential is applied to the remaining electrodes 3111, 3121, 3112, 3122, 3113, the droplet 70 may move over the sixth electrode 3114. Alternatively, after the droplet 70 moves to the surface of the fourth electrode 3122, when the operating signal is applied to the fifth electrode 3113 and the sixth electrode 3114 and the reference potential is applied to the remaining electrodes 3111, 3121, 3112, 3122, the droplet 70 may be split or spread over the fifth electrode 3113 and the sixth electrode 3114.

FIG. 39 is a plan view illustrating an embodiment of applying a vertical electrode arrangement according to the present disclosure to a reservoir area and a distribution area of the droplet actuator when viewed from above the upper substrate.

Referring to FIG. 39, the first electrode 3111, the second electrode 3121, the third electrode 3112, the fourth electrode 3122, and the fifth electrode 3113 are sequentially arranged in a direction from the reservoir area toward a fluid channel. The first electrode 3111, the third electrode 3112, and the fifth electrode 3113 may be electrodes formed on the lower substrate, and the second electrode 3121 and the fourth electrode 3122 may be electrodes formed on the upper substrate.

At this time, the first electrode 3111 and the second electrode 3121 may be reservoir electrodes for guiding the flow of fluid in the reservoir, and the third electrode 3112, the fourth electrode 3122, and the fifth electrode 3113 may be distribution electrodes for distributing a droplet from the reservoir and transferring it to the fluid channel.

The reservoir electrodes 3111, 3121 may have a different size from the distribution electrodes 3112, 3122, 3113. The reservoir electrodes 3111, 3121 are generally formed with a larger size than the distribution electrodes 3112, 3122, 3113. FIG. 39 illustrates that the vertical electrode arrangement according to the present disclosure may be applied even when electrowetting electrodes of different sizes are mixed.

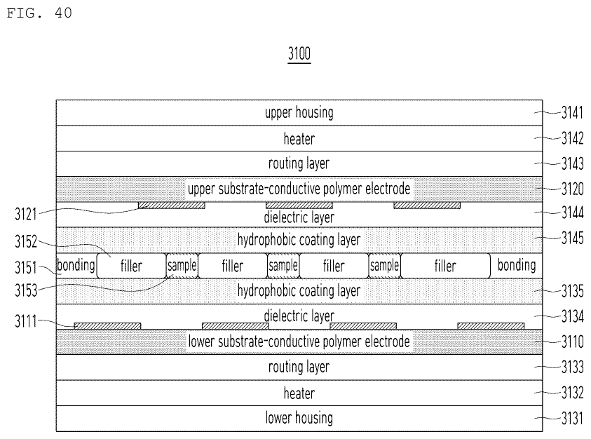

FIG. 40 is a view illustrating an exemplary stacked structure of the droplet actuator illustrated in FIG. 33.

Referring to FIG. 40, the droplet actuator 3100 having a stacked structure according to the present embodiment includes a lower plate where a lower housing 3131, a heater 3132, a routing layer 3133, a lower substrate 3110, a dielectric layer 3134, and a hydrophobic coating layer 3135 are sequentially stacked, and an upper plate where a hydrophobic coating layer 3145, a dielectric layer 3144, an upper substrate 3120, a routing layer 3143, a heater 3142, and an upper housing 3141 are sequentially stacked. At this time, the upper plate and the lower plate may be spaced apart from each other so that a space is formed therebetween to receive a droplet therein.

The space may have a bonding 3151 that joins the upper plate and the lower plate, at least one filler 3152, and/or at least one sample 3153.

The lower housing 3131 is a configuration that forms the lower exterior of the droplet actuator 3100, protects the internal configuration of the droplet actuator 3100, and provides an interface for connecting the droplet actuator 3100 and an external device (e.g., a tester). In one embodiment, the lower housing 3131 may include a polymer or plastic.

The heater 3132 is a configuration for heating the droplet inside the droplet actuator 3100, and may be a resistive heater, a magnetic induction heater, or a thermoelectric heater.

The routing layer 3133 is an interconnection layer for electrically connecting the droplet actuator 3100 and the external device (e.g., the tester), and may include a contact pad pattern. At this time, the contact pad is connected to a conductive element (e.g., a conductive polymer) of the lower substrate 3110 through a via. In one embodiment, the routing layer 3133 may include a metal (e.g., Ag, Au, Cu, Cr, etc.) and a conductive polymer. In one embodiment, the routing layer 3133 may be formed by evaporation, sputtering, screen printing, inkjet printing, laser ablation, or an R2R process.

The lower substrate 3110 is a layer on which an electrowetting electrode 3111 is formed, and electrically connects the routing layer 3133 and the electrowetting electrode 3111 to each other. The lower substrate 3110 may include a base and a conductive plastic that is filled through the base. In one embodiment, the base may include a polymer (e.g., PMMA, PC, COP, etc.), ceramic, glass, or silicone. In one embodiment, the lower substrate 3110 may be formed by injection molding, dispensing, screen printing, or 3D printing.

Meanwhile, in one embodiment, the electrowetting electrode 3111 is an electrode for inducing electrowetting, may include a metal (e.g., Ag, Au, Cu, Cr, etc.) or a conductive polymer, and may be formed by evaporation, sputtering, screen printing, inkjet printing, laser ablation, or an R2R process.

The dielectric layer 3134 is a layer formed on the lower substrate 3110 or the electrowetting electrode 3111 to provide electrical insulation to the lower substrate 3110 or the electrowetting electrode 3111, and may be a thin film coating structure. The dielectric layer 3134 may include various insulating materials such as SiO₂, Si₃N₄, parylene, fluoropolymer, SU8, or PDMS, and may be formed by spin coating, dip coating, spray coating, plasma coating, evaporation, sputtering, ALD, CVD, or an e-beam process.

The hydrophobic coating layer 3135 is a layer for hydrophobicizing a surface of the dielectric layer 3134, and may be a thin film coating structure. The hydrophobic coating layer 3135 may include a fluoropolymer, and may be formed by spin coating, dip coating, spray coating, plasma coating, evaporation, sputtering, ALD, CVD, or an e-beam process.

A gap spacer for forming a gap is formed between the hydrophobic coating layers 3135, 3145.

The gap spacer is a space that receives the droplet and a filler fluid therein and where the upper plate and the lower plate are connected to each other. The gap spacer is formed by a spacer, and may be formed by bonding the spacer and the upper plate and/or the lower plate using laser welding, ultrasonic welding, heat welding, pressure welding, or an adhesive. The height of the gap spacer may be adjusted by the spacer.

Meanwhile, the spacer may be a separate configuration distinct from the upper plate and the lower plate, or may be a configuration included as a part of the upper plate or the lower plate. In one embodiment, the spacer may include a polymer.

In one embodiment, the bonding 3151 may function as a spacer to form the gap spacer.

The hydrophobic coating layer 3145 is a layer for hydrophobicizing a surface of the dielectric layer 3144, and may be a thin film coating structure. The hydrophobic coating layer 3145 may include a fluoropolymer, and may be formed by spin coating, dip coating, spray coating, plasma coating, evaporation, sputtering, ALD, CVD, or an e-beam process.

The dielectric layer 3144 is a layer formed on the upper substrate 3120 or an electrowetting electrode 3121 to provide electrical insulation to the upper substrate 3120 or the electrowetting electrode 3121, and may be a thin film coating structure. The dielectric layer 3144 may include various insulating materials such as SiO₂, Si₃N₄, parylene, fluoropolymer, SU8, or PDMS, and may be formed by spin coating, dip coating, spray coating, plasma coating, evaporation, sputtering, ALD, CVD, or an e-beam process.

The upper substrate 3120 is a layer on which the electrowetting electrode 3121 is formed, and electrically connects the routing layer 3143 and the electrowetting electrode 3121 to each other. The upper substrate 3120 may include a base and a conductive plastic that is filled through the base. In one embodiment, the base may include a polymer (e.g., PMMA, PC, COP, etc.), ceramic, glass, or silicone. In one embodiment, the upper substrate 3120 may be formed by injection molding, dispensing, screen printing, or 3D printing.

Meanwhile, in one embodiment, the electrowetting electrode 3121 is an electrode for inducing electrowetting, may include a metal (e.g., Ag, Au, Cu, Cr, etc.) or a conductive polymer, and may be formed by evaporation, sputtering, screen printing, inkjet printing, laser ablation, or an R2R process.

The routing layer 3143 is an interconnection layer for electrically connecting the droplet actuator 3100 and the external device (e.g., the tester), and may include a contact pad pattern. At this time, the contact pad is connected to a conductive element (e.g., a conductive polymer) of the upper substrate 3120 through a via. In one embodiment, the routing layer 3143 may include a metal (e.g., Ag, Au, Cu, Cr, etc.) and a conductive polymer. In one embodiment, the routing layer 3143 may be formed by evaporation, sputtering, screen printing, inkjet printing, laser ablation, or an R2R process.

The heater 3142 is a configuration for heating the droplet inside the droplet actuator 3100, and may be a resistive heater, a magnetic induction heater, or a thermoelectric heater.

The upper housing 3141 is a configuration that forms the upper exterior of the droplet actuator 3100, protects the internal configuration of the droplet actuator 3100, and provides an interface for connecting the droplet actuator 3100 and the external device (e.g., the tester). In one embodiment, the upper housing 3141 may include a polymer or plastic.

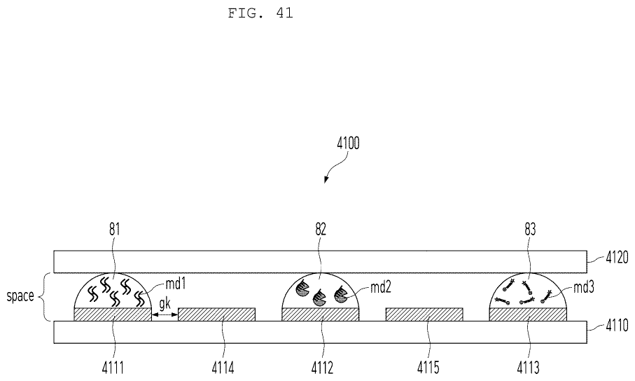

In FIG. 41 and below, described will be a droplet processing method of determining the presence of a target substance in a droplet or the concentration of the target substance in the droplet using the droplet actuators according to the various embodiments described above.

FIGS. 41 to 45 are views illustrating an embodiment of a droplet processing method for determining the presence and concentration of a target nucleic acid in a droplet. Referring to FIG. 41, illustrated is a droplet actuator 4100 used for the droplet processing method according to the present embodiment.

The droplet actuator 4100 is a device that processes movement, merging, and/or separation of droplets based on electrowetting, and may be any one of the droplet actuators of various structures described with reference to FIGS. 1 to 40. In FIG. 41, the droplet actuator 4100 is illustrated as having electrowetting electrodes formed only on a lower substrate, but this is merely exemplary for simplicity of explanation, and the scope of the present embodiment is not limited thereto. For example, the droplet actuator 4100 illustrated in FIG. 41 may have electrowetting electrodes formed on each of upper and lower substrates, like the droplet actuator 3100 illustrated in FIG. 33. The description will be given below in more detail with reference to the drawings.

The droplet actuator 4100 includes an upper substrate 4120, a lower substrate 4110 spaced apart from the upper substrate 4120 and having a space formed between the upper substrate and the upper substrate and through which a droplet moves, and a plurality of electrodes (or electrowetting electrodes) 4111, 4112, 4113, 4114, 4115 arranged on the upper substrate 4120 or the lower substrate 4110 and having a potential variable by an electrowetting signal. The plurality of electrodes 4111, 4112, 4113, 4114, 4115 are spaced apart from each other by a gap gk.

Within the space, a first droplet 81 containing a target nucleic acid md1 is located on a first electrode 4111, a second droplet 82 containing genetic scissors md2 is located on a second electrode 4112, and a third droplet 83 containing a reactant md3 is located on a third electrode 4113. In one embodiment, the target nucleic acid md1 may be single stranded RNA, single stranded DNA, or double stranded DNA.

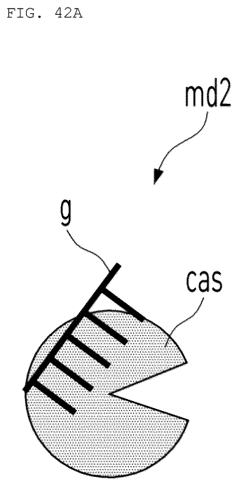

In one embodiment, the genetic scissors md2 is a genetic scissors that is activated by binding to the target nucleic acid md1, and may be a protein complex including a CAS protein and a gRNA. Alternatively, in one embodiment, the reactant md3 may be a complex including a reporter and a quencher. This will be described in more detail with reference to FIG. 42.

FIG. 42A illustrates an exemplary configuration of the genetic scissors md2. The genetic scissors md2 may be a combination of CAS protein cas and gRNA g.

The CAS protein cas is an enzyme that non-specifically cleaves a target nucleic acid, and may be a CRISPR-associated endonuclease.

The gRNA g is RNA that complementarily binds to the target nucleic acid to be cleaved, and designates the target nucleic acid to be cleaved by the genetic scissors md2 or activates the genetic scissors md2 to induce non-specific nucleic acid cleavage. The gRNA g may be single guide RNA (sgRNA).

FIG. 42B illustrates an exemplary configuration of the reactant md3. The reactant md3 may be a combination of a reporter rp and a quencher qc bound by a nucleic acid st. In one embodiment, the nucleic acid st may be a single stranded nucleic acid.

The reporter rp is a luminescent substance bound to one end of the nucleic acid st, and the quencher qc is a light-absorbing substance bound to the other end of the nucleic acid st. When the reporter rp and the quencher qc are bound to each other, the quencher qc suppresses the reporter rp and thus no light is emitted, but when the bond between the reporter rp and the quencher qc is broken, the reporter rp freely emits light.

In this manner, when the first droplet 81 containing the target nucleic acid md1, the second droplet 82 containing the genetic scissors md2, and the third droplet 83 containing the reactant md3 are prepared in the space within the droplet actuator 4100, droplet processing may be performed by applying an electrowetting signal may be applied to the electrodes 4111, 4112, 4113, 4114, 4115 of the droplet actuator 4100.

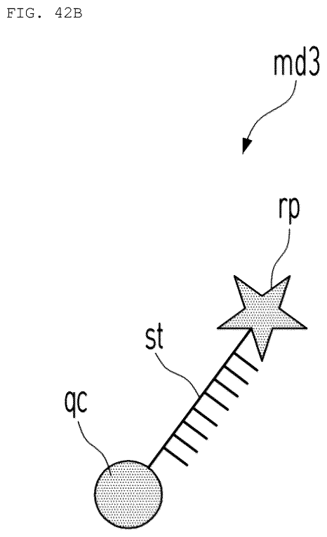

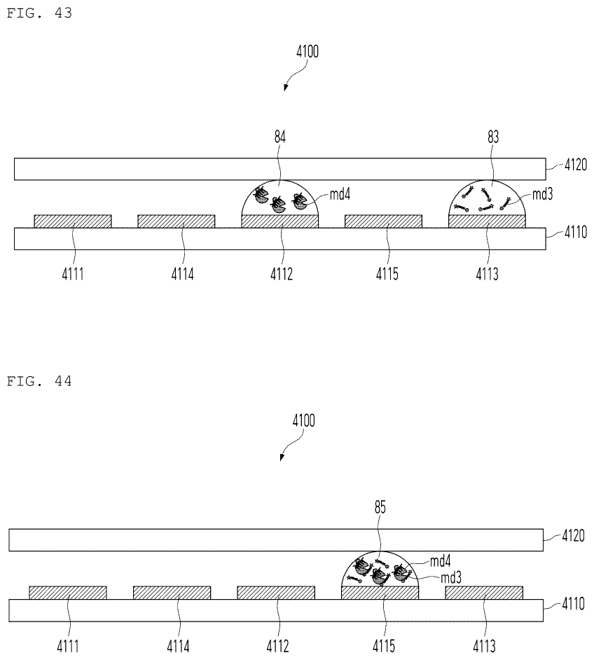

First, referring to FIG. 43 together, by a first droplet manipulation based on a first electrowetting signal, the first droplet 81 containing the target nucleic acid md1 and the second droplet 82 containing the genetic scissors md2 are merged to form a droplet 84. The resultant droplet is provided in an internal space of the droplet actuator 4100, e.g., on a fluid channel of the droplet actuator 4100.

In one embodiment, the first droplet manipulation may be a manipulation of moving the first droplet 81 on the first electrode 4111 toward the second droplet 82, a manipulation of moving the second droplet 82 on the second electrode 4112 toward the first droplet 81, or a manipulation of moving the first droplet 81 on the first electrode 4111 and the second droplet 82 on the second electrode 4112 toward the fourth electrode 4114 interposed therebetween. In FIG. 43, the first droplet manipulation is exemplified as a manipulation of moving the first droplet 81 on the first electrode 4111 toward the second droplet 82.

In one embodiment, the first electrowetting signal may be an electric signal (e.g., V1, V2, V3, V4 illustrated in FIG. 37) selectively applied to each of the electrodes 4111, 4112, 4113, 4114, 4115 so that the first droplet manipulation is implemented.

Within the droplet 84, the genetic scissors md2 may be activated by binding to the target nucleic acid md1. The activated genetic scissors md4 may cleave a nucleic acid.

Meanwhile, in the above, the case where the first droplet 81 and the second droplet 82 are merged to create the droplet 84 through droplet manipulation based on the electrowetting signal has been exemplified, but the scope of the present disclosure is not limited thereto.

For example, the creation of the droplet 84 may not be accomplished by merging the first droplet 81 and the second droplet 82 through droplet manipulation, and the droplet 84 may be injected from the outside while containing the activated genetic scissors md4 and provided in the internal space of the droplet actuator 4100, e.g., on the fluid channel of the droplet actuator 4100.

Next, referring to FIG. 44 together, by a second droplet manipulation based on a second electrowetting signal, the droplet 84 containing the activated genetic scissors md4 and the third droplet 83 containing the reactant md3 are merged to form a merged droplet 85. Within the merged droplet 85, the activated genetic scissors md4 are mixed with the reactant md3, causing a reaction of the reactant md3. At this time, the reaction may be a reaction in which the bond between the reporter rp and the quencher qc in the reactant md3 is broken or the reporter rp emits light.

This will be described in more detail with reference to FIG. 45. When the activated genetic scissors md4 are mixed with the reactant md3 within the merged droplet 85, the activated genetic scissors md4 non-specifically cleaves the nucleic acid st. When the nucleic acid st is cleaved, the reporter rp is separated from the quencher qc, and the reporter rp emits light as a reaction to an action of the activated genetic scissors md4.

At this time, the amount of light emitted from the reporter rp may be measured to determine the presence of the target nucleic acid md1 in the droplet and/or the concentration of the target nucleic acid md1 in the droplet.

For example, when the target nucleic acid md1 does not exist in the first droplet 81, the genetic scissors md2 may not be activated in the droplet 84, and the non-activated genetic scissors md2 may not be able to cleave the nucleic acid st of the reactant md3. As a result, light emission from the reporter rp may not occur in the merged droplet 85.

In another embodiment, when the target nucleic acid md1 exists in the first droplet 81, the genetic scissors md2 may be activated in the droplet 84. The activated genetic scissors md4 may cleave the nucleic acid st of the reactant md3, causing the reporter rp to be separated from the quencher qc and light to be emitted from the reporter rp. At this time, the amount of light generated by the reporter rp may vary depending on the amount of target nucleic acid md1 in the first droplet 81.

For example, when a large amount of target nucleic acid md1 exists in the first droplet 81, a relatively larger amount of genetic scissors md2 may be activated and thus cleave more nucleic acids st of the reactant md3, resulting in a relatively larger amount of light emitted from the reporter rp.

On the other hand, when a small amount of target nucleic acid md1 exists in the first droplet 81, a relatively smaller amount of genetic scissors md2 may be activated, resulting in a relatively smaller amount of light emitted from the reporter rp.

In one embodiment, the second droplet manipulation may be a manipulation of moving the droplet 84 on the second electrode 4112 toward the third droplet 83, a manipulation of moving the third droplet 83 on the third electrode 4113 toward the droplet 84, or a manipulation of moving the droplet 84 on the second electrode 4112 and the third droplet 83 on the third electrode 4113 toward the fifth electrode 4115 interposed therebetween. In FIG. 44, the second droplet manipulation is exemplified as a manipulation of moving the droplet 84 on the second electrode 4112 and the third droplet 83 on the third electrode 4113 toward the fifth electrode 4115 interposed therebetween.

In one embodiment, the second electrowetting signal may be an electric signal (e.g., V1, V2, V3, V4 illustrated in FIG. 37) selectively applied to each of the electrodes 4111, 4112, 4113, 4114, 4115 so that the second droplet manipulation is implemented.

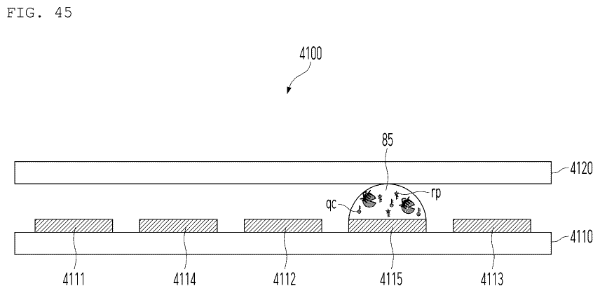

FIGS. 46 to 49 are views illustrating another embodiment of a droplet processing method for determining the presence and concentration of a target substance in a droplet. Referring to FIG. 46, illustrated is a droplet actuator 4100 used for the droplet processing method according to the present embodiment.

The configuration of the droplet actuator 4100 illustrated in FIG. 46 remains the same as that of the droplet actuator 4100 illustrated in FIG. 41. In addition, in FIG. 46, the composition and function of a target nucleic acid md1, genetic scissors md2, and a reactant md3 remain the same as those described above with reference to FIGS. 41 to 45. However, in the present embodiment, there is a difference in that the reactant md3 is prepared on a surface on an electrode 4115 rather than contained in a droplet.

When the target nucleic acid md1, the genetic scissors md2, and the reactant md3 are prepared in the droplet actuator 4100, droplet processing may be performed by applying an electrowetting signal to electrodes 4111, 4112, 4113, 4114, 4115 of the droplet actuator 4100.

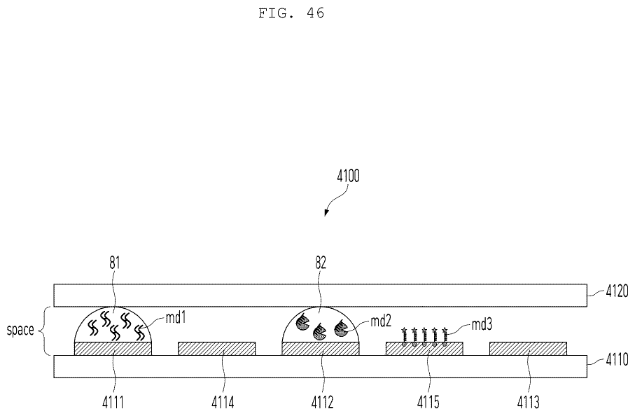

Referring to FIG. 47 together, by a first droplet manipulation based on a first electrowetting signal, a first droplet 81 containing the target nucleic acid md1 and a second droplet 82 containing the genetic scissors md2 are merged to form a droplet 84. The resultant droplet is provided in an internal space of the droplet actuator 4100, e.g., on a fluid channel of the droplet actuator 4100.

At this time, the first droplet manipulation and the first electrowetting signal may be the same as the first droplet manipulation and the first electrowetting signal described above with reference to FIGS. 41 to 45.

Within the droplet 84, the genetic scissors md2 may be activated by binding to the target nucleic acid md1. The activated genetic scissors md4 may cleave a nucleic acid.

Meanwhile, as in the example of FIG. 43, the creation of the droplet 84 may not be accomplished by merging the first droplet 81 and the second droplet 82 through droplet manipulation, and the droplet 84 may be injected from the outside while containing the activated genetic scissors md4 and provided in the internal space of the droplet actuator 4100, e.g., on the fluid channel of the droplet actuator 4100.

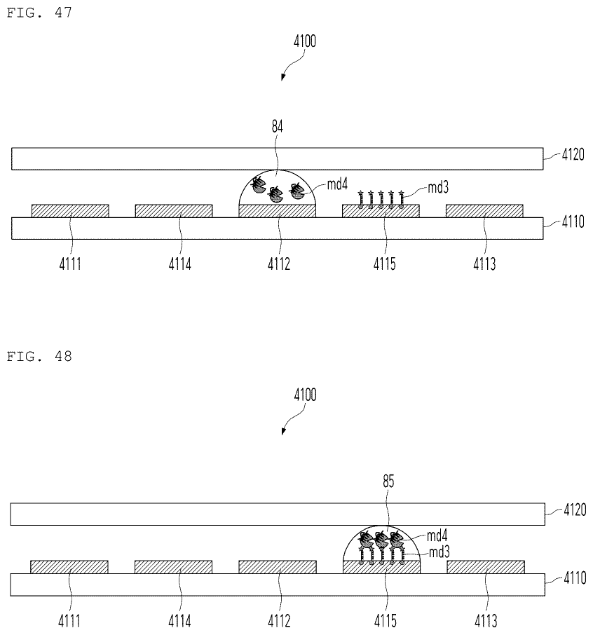

Next, referring to FIG. 48 together, by a second droplet manipulation based on a second electrowetting signal, the droplet 84 containing the activated genetic scissors md4 moves to the position where the reactant md3 is prepared, thereby providing the reactant md3 within the droplet 84.

In one embodiment, the second droplet manipulation may be a manipulation of moving the droplet 84 on a second electrode 4112 toward a fifth electrode 4115.

In one embodiment, the second electrowetting signal may be an electric signal (e.g., V1, V2, V3, V4 illustrated in FIG. 37) selectively applied to each of the electrodes 4111, 4112, 4113, 4114, 4115 so that the second droplet manipulation is implemented.

In one embodiment, the reactant md3 may be provided in a form placed on the surface of the electrode as illustrated in FIG. 48.

Within the droplet 84, the activated genetic scissors md4 are mixed with the reactant md3, causing a reaction of the reactant md3. At this time, the reaction may be a reaction in which the bond between a reporter rp and a quencher qc in the reactant md3 is broken or the reporter rp emits light. However, this is merely exemplary, and the quencher qc may not exist in the reactant md3.

When the reporter rp is separated from the quencher qc by the reaction, the separated reporter rp emits light while floating within the droplet 84. At this time, in order to more easily observe the light emission from the reporter rp, the droplet 84 may be allowed to move to a different position.

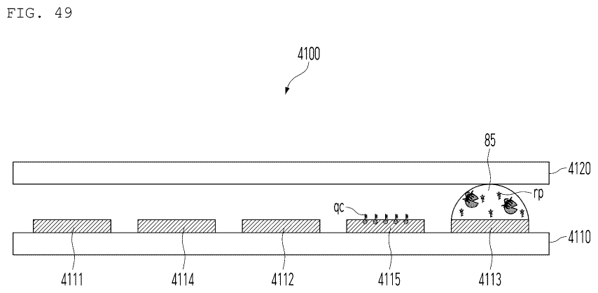

This will be described in more detail with reference to FIG. 49. After the reporter rp is separated from the quencher qc, the droplet 84 moves from the fifth electrode 4115 to a third electrode 4113 by a third droplet manipulation based on a third electrowetting signal. At this time, since the reporter rp floats within the droplet 84, it moves to the third electrode 4113 together with the droplet 84. Since the quencher qc is fixed to the surface of the fifth electrode 4115, it remains on the surface.

In one embodiment, the third electrode 4113 may be a point where light emission from the reporter rp is easy to observe. For example, the point may be a position where a transparent hole is formed at an opposing position to the third electrode 4113 or the third electrode 4113 is configured as a transparent electrode, in order to enable easier observation of light emission.

When the droplet 84 moves to the third electrode 4113, the amount of light emitted from the reporter rp contained in the droplet 84 may be measured to determine the presence of the target nucleic acid md1 in the droplet and/or the concentration of the target nucleic acid md1 in the droplet. The principle of determining the presence and concentration of the target nucleic acid md1 by measuring the amount of light emitted from the reporter rp has been described in the previous embodiment, so a further description thereof is omitted.

In one embodiment, the third droplet manipulation may be a manipulation of moving the droplet 84 on the fifth electrode 4115 toward the third electrode 4113.

In one embodiment, the third electrowetting signal may be an electric signal (e.g., V1, V2, V3, V4 illustrated in FIG. 37) selectively applied to each of the electrodes 4111, 4112, 4113, 4114, 4115 so that the third droplet manipulation is implemented.

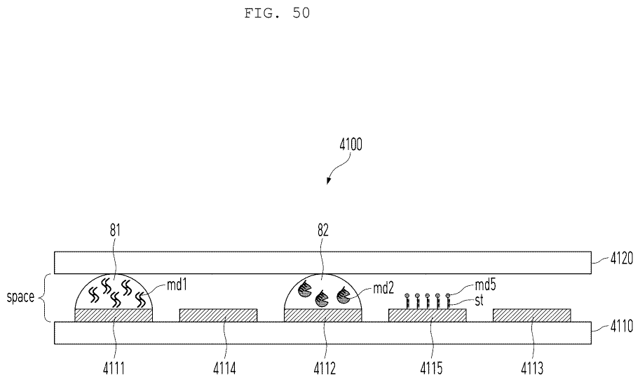

FIGS. 50 to 53 are views illustrating another embodiment of a droplet processing method for determining the presence and concentration of a target nucleic acid in a droplet. Referring to FIG. 50, illustrated is a droplet actuator 4100 used for the droplet processing method according to the present embodiment.

The configuration of the droplet actuator 4100 illustrated in FIG. 50 remains the same as that of the droplet actuator 4100 illustrated in FIG. 46. In addition, in FIG. 50, the composition and function of a target nucleic acid md1 and genetic scissors md2 remain the same as those described above with reference to FIG. 46. However, in the present embodiment, there is a difference in that a reactant md5 is not composed of a reporter rp and a quencher qc, but is a hydrophobic molecule or a hydrophilic molecule fixed to a surface on an electrode 4115 by a nucleic acid st.

When the target nucleic acid md1, the genetic scissors md2, and the reactant md5 are prepared in the droplet actuator 4100, droplet processing may be performed by applying an electrowetting signal to electrodes 4111, 4112, 4113, 4114, 4115 of the droplet actuator 4100.

Referring to FIG. 51 together, by a first droplet manipulation based on a first electrowetting signal, a first droplet 81 containing the target nucleic acid md1 and a second droplet 82 containing the genetic scissors md2 are merged to form a droplet 84. The resultant droplet is provided in an internal space of the droplet actuator 4100, e.g., on a fluid channel of the droplet actuator 4100.

At this time, the first droplet manipulation and the first electrowetting signal may be the same as the first droplet manipulation and the first electrowetting signal described above with reference to FIGS. 46 to 49.

Within the droplet 84, the genetic scissors md2 may be activated by binding to the target nucleic acid md1. The activated genetic scissors md4 may cleave a nucleic acid.

Meanwhile, as in the example of FIG. 43 or FIG. 47, the creation of the droplet 84 may not be accomplished by merging the first droplet 81 and the second droplet 82 through droplet manipulation, and the droplet 84 may be injected from the outside while containing the activated genetic scissors md4 and provided in the internal space of the droplet actuator 4100, e.g., on the fluid channel of the droplet actuator 4100.

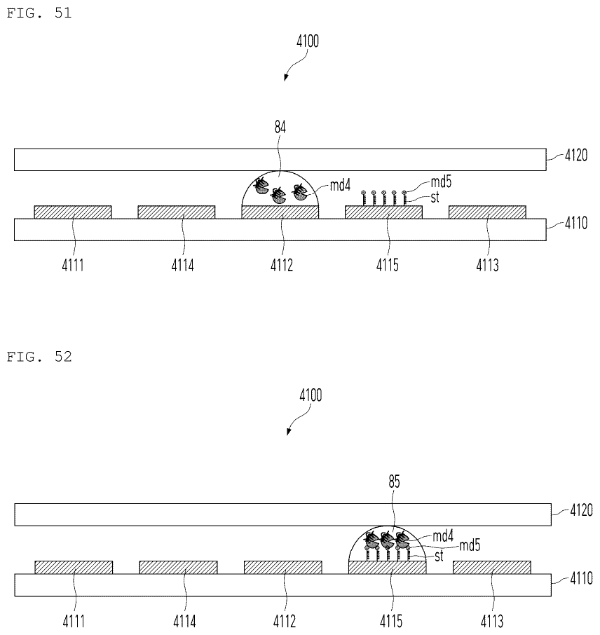

Next, referring to FIG. 52 together, by a second droplet manipulation based on a second electrowetting signal, the droplet 84 containing the activated genetic scissors md4 moves to the position where the reactant md5 is prepared, and the activated genetic scissors md4 are mixed with the reactant md5 within a droplet 85, causing a reaction of the reactant md5. At this time, the reaction may be a reaction in which the nucleic acid st bound to the reactant md5 is cleaved by the activated genetic scissors md4, or a reaction in which the reactant md5 floats as a result of the cleavage to change the degree of hydrophobicity or hydrophilicity of the surface on the electrode 4115.

In one embodiment, the second droplet manipulation may be a manipulation of moving the droplet 84 on a second electrode 4112 toward a fifth electrode 4115.

In one embodiment, the second electrowetting signal may be an electric signal (e.g., V1, V2, V3, V4 illustrated in FIG. 37) selectively applied to each of the electrodes 4111, 4112, 4113, 4114, 4115 so that the second droplet manipulation is implemented.

When the single stranded nucleic acid st fixed to the surface of the fifth electrode 4115 is cleaved as a result of the reaction, the reactant md5 fixed by the nucleic acid st is separated from the surface of the fifth electrode 4115 and floats within the droplet 84. At this time, since the floating reactant md5 is a hydrophobic molecule or a hydrophilic molecule, it may cause a change in the degree of hydrophobicity or hydrophilicity of the surface on the electrode 4115.

Meanwhile, in order to more easily observe the change caused by the floating reactant md5, the droplet 84 may be allowed to move to a different position.

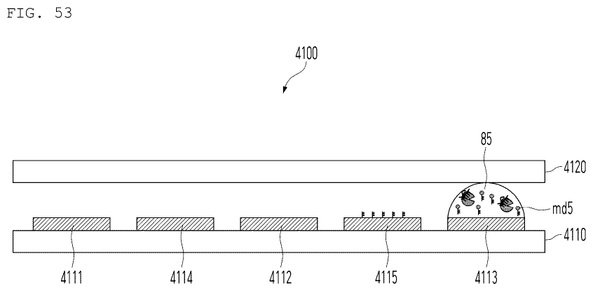

This will be described in more detail with reference to FIG. 53. After the reactant md5 is separated from the surface of the fifth electrode 4115, the droplet 84 moves from the fifth electrode 4115 to a third electrode 4113 by a third droplet manipulation based on a third electrowetting signal. At this time, since the reactant md5 floats within the droplet 84, it moves to the third electrode 4113 together with the droplet 84.

In one embodiment, configurations may be provided for measuring a change in the degree of hydrophobicity or hydrophilicity of the surface on the fifth electrode 4115. For example, a sensor for measuring the degree of hydrophobicity or hydrophilicity in a fluid may be provided in the vicinity of the fifth electrode 4115, or the sensor may be electrically connected to the fifth electrode 4115. Alternatively, a sample for visualizing a change in the degree of hydrophobicity or the degree of hydrophilicity of the droplet 84 may be provided on the fifth electrode 4115.

When the droplet 84 moves to the third electrode 4113, the degree of hydrophobicity or hydrophilicity of the surface on the electrode 4115 may be measured to determine the presence of the target nucleic acid md1 in the droplet and the concentration of the target nucleic acid md1 in the droplet.

For example, when the target nucleic acid md1 does not exist in the first droplet 81, the genetic scissors md2 may not be activated in the droplet 84, and the non-activated genetic scissors md2 may not be able to cleave the nucleic acid st bound to the reactant md5. As a result, the reactant md5 may remain fixed on the fifth electrode 4115, and the degree of hydrophobicity or hydrophilicity of the surface on the electrode 4115 may not be changed even after the droplet 84 moves to the third electrode 4113.

In another embodiment, when the target nucleic acid md1 exists in the first droplet 81, the genetic scissors md2 may be activated in the droplet 84. The activated genetic scissors md4 may cleave the nucleic acid st bound to the reactant md5, causing the reactant md5 to be separated from the surface and float within the droplet 84. After the droplet 84 moves to the third electrode 4113, the reactant md5 floating within the droplet 84 may also move to the third electrode 4113 along the droplet 84, and since the reactant md5 is a hydrophobic molecule or a hydrophilic molecule, the degree of hydrophobicity or hydrophilicity of the surface on the electrode 4115 may be changed depending on the amount of the reactant md5 moved along the droplet 84. Therefore, the degree of hydrophobicity or hydrophilicity of the surface on the electrode 4115 may be measured to determine the presence of the target nucleic acid md1 in the first droplet 81.

At this time, the amount of change in the degree of hydrophobicity or hydrophilicity of the surface on the electrode 4115 may vary depending on the amount of target nucleic acid md1 in the first droplet 81.

For example, when a large amount of target nucleic acid md1 exists in the first droplet 81, a relatively larger amount of genetic scissors md2 may be activated and thus cleave more nucleic acids st of the reactant md5, resulting in a relatively larger change in the degree of hydrophobicity or hydrophilicity of the surface on the electrode 4115.

On the other hand, when a small amount of target nucleic acid md1 exists in the first droplet 81, a relatively smaller amount of genetic scissors md2 may be activated, resulting in a relatively smaller change in the degree of hydrophobicity or hydrophilicity of the surface on the electrode 4115.

Therefore, by measuring the degree of hydrophobicity or hydrophilicity of the surface on the electrode 4115, the presence of the target nucleic acid md1 in the droplet and/or the concentration of the target nucleic acid md1 in the droplet may be determined.

In one embodiment, the third droplet manipulation may be a manipulation of moving the droplet 84 on the fifth electrode 4115 toward the third electrode 4113.

In one embodiment, the third electrowetting signal may be an electric signal (e.g., V1, V2, V3, V4 illustrated in FIG. 37) selectively applied to each of the electrodes 4111, 4112, 4113, 4114, 4115 so that the third droplet manipulation is implemented.

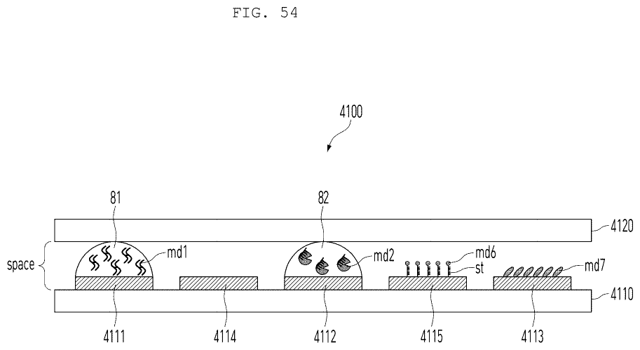

FIGS. 54 to 57 are views illustrating another embodiment of a droplet processing method for determining the presence and concentration of a target nucleic acid in a droplet. Referring to FIG. 54, illustrated is a droplet actuator 4100 used for the droplet processing method according to the present embodiment.

The configuration of the droplet actuator 4100 illustrated in FIG. 54 remains the same as that of the droplet actuator 4100 illustrated in FIG. 50. In addition, in FIG. 54, the composition and function of a target nucleic acid md1 and genetic scissors md2 remain the same as those described above with reference to FIG. 50. However, in the present embodiment, there is a difference in that a first reactant md6 is fixed to a surface on a fifth electrode 4115, and a second reactant md7 is fixed to a surface on a third electrode 4113.

At this time, the first reactant md6 may be an enzyme, catalyst, or substrate fixed to the surface on the fifth electrode 4115 by a nucleic acid st, and the second reactant md7 may be a substance that electrochemically reacts with the enzyme, catalyst, or substrate to cause an oxidation reaction or a reduction reaction.

When the target nucleic acid md1, the genetic scissors md2, and the reactant md6 are prepared in the droplet actuator 4100, droplet processing may be performed by applying an electrowetting signal to electrodes 4111, 4112, 4113, 4114, 4115 of the droplet actuator 4100.

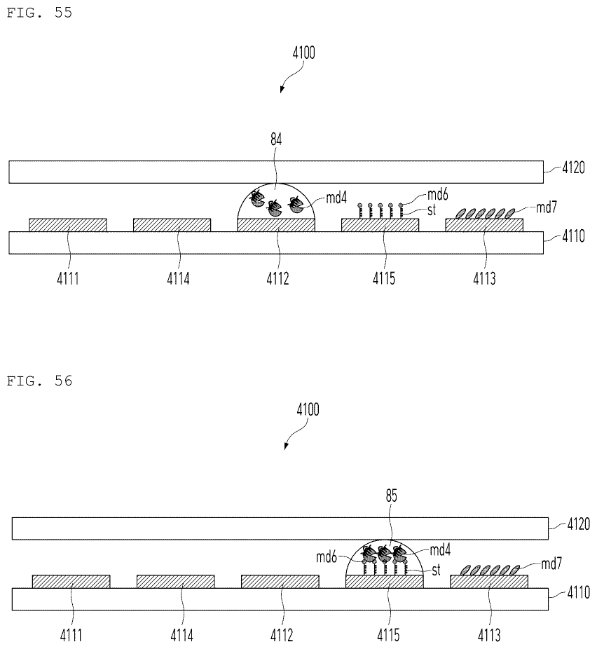

Referring to FIG. 55 together, by a first droplet manipulation based on a first electrowetting signal, a first droplet 81 containing the target nucleic acid md1 and a second droplet 82 containing the genetic scissors md2 are merged to form a droplet 84. The resultant droplet is provided in an internal space of the droplet actuator 4100, e.g., on a fluid channel of the droplet actuator 4100.

At this time, the first droplet manipulation and the first electrowetting signal may be the same as the first droplet manipulation and the first electrowetting signal described above with reference to FIGS. 46 to 49.

Within the droplet 84, the genetic scissors md2 may be activated by binding to the target nucleic acid md1. The activated genetic scissors md4 may cleave a nucleic acid.

Meanwhile, as in the example of FIG. 43 or FIG. 47, the creation of the droplet 84 may not be accomplished by merging the first droplet 81 and the second droplet 82 through droplet manipulation. For example, the droplet 84 may be injected from the outside while containing the activated genetic scissors md4 and provided on the fluid channel of the droplet actuator 4100.

Next, referring to FIG. 56 together, by a second droplet manipulation based on a second electrowetting signal, the droplet 84 containing the activated genetic scissors md4 moves to the position where the first reactant md6 is prepared, and the activated genetic scissors md4 are mixed with the first reactant md6 within a droplet 85, causing a reaction of the first reactant md6. At this time, the reaction may be a reaction in which the nucleic acid st bound to the first reactant md6 is cleaved by the activated genetic scissors md4, or a reaction in which the first reactant md6 floats as a result of the cleavage.

In one embodiment, the second droplet manipulation may be a manipulation of moving the droplet 84 on a second electrode 4112 toward a fifth electrode 4115.

In one embodiment, the second electrowetting signal may be an electric signal (e.g., V1, V2, V3, V4 illustrated in FIG. 37) selectively applied to each of the electrodes 4111, 4112, 4113, 4114, 4115 so that the second droplet manipulation is implemented.

When the nucleic acid st fixed to the surface of the fifth electrode 4115 is cleaved as a result of the reaction, the first reactant md6 fixed by the nucleic acid st is separated from the surface of the fifth electrode 4115 and floats within the droplet 84.

At this time, since the first reactant md6 includes the enzyme, catalyst, or substrate that causes an oxidation reaction or reduction reaction by acting on the second reactant md7, when a larger amount of floating first reactant md6 electrochemically reacts with the second reactant md7, a larger amount of oxidation or reduction reaction may occur. Therefore, the amount of optical or electrical change due to the oxidation or reduction reaction occurring at that time may be measured to determine the presence of the target nucleic acid md1 in the droplet and the concentration of the target nucleic acid md1 in the droplet.

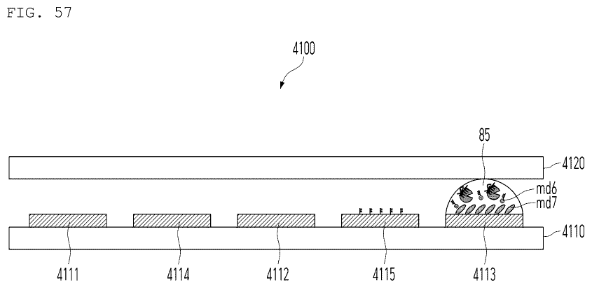

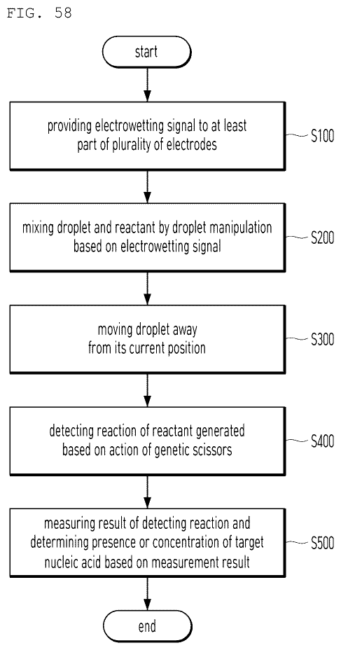

This will be described in more detail with reference to FIG. 57. After the first reactant md6 is separated from the surface of the fifth electrode 4115, the droplet 84 moves from the fifth electrode 4115 to a third electrode 4113 by a third droplet manipulation based on a third electrowetting signal. At this time, since the first reactant md6 floats within the droplet 84, it moves to the third electrode 4113 together with the droplet 84.

Then, the first reactant md6 meets and mixes with the second reactant md7 on the third electrode 4113, and the first reactant md6 and the second reactant md7 electrochemically react with each other to cause an oxidation reaction or a reduction reaction.

At this time, the amount of optical or electrical change due to the oxidation reaction or reduction reaction may be detected by an optical or electrical method through a sensor or the like connected to the third electrode 4113, and the presence of the target nucleic acid md1 in the droplet and the concentration of the target nucleic acid md1 in the droplet may be determined on the basis of the detection result.

For example, when the target nucleic acid md1 does not exist in the first droplet 81, the genetic scissors md2 may not be activated in the droplet 84, and the non-activated genetic scissors md2 may not be able to cleave the nucleic acid st bound to the first reactant md6. As a result, the first reactant md6 may remain fixed on the fifth electrode 4115, and the oxidation and reduction reactions may not occur even after the droplet 84 moves to the third electrode 4113.

In another embodiment, when the target nucleic acid md1 exists in the first droplet 81, the genetic scissors md2 may be activated in the droplet 84. The activated genetic scissors md4 may cleave the nucleic acid st bound to the first reactant md6, causing the first reactant md6 to be separated from the surface and float within the droplet 84. Thereafter, when the droplet 84 moves to the third electrode 4113, the first reactant md6 floating within the droplet 84 may also move to the third electrode 4113 along the droplet 84, and when the first reactant md6 is mixed with the second reactant md7 and reacts with it electrochemically, the oxidation reaction or a reduction reaction may occur. Therefore, by measuring whether the oxidation reaction or reduction reaction occurs, the presence of the target nucleic acid md1 in the first droplet 81 may be determined.

At this time, the amount of optical or electrical change due to the oxidation reaction or reduction reaction may vary depending on the amount of target nucleic acid md1 in the first droplet 81.

For example, when a large amount of target nucleic acid md1 exists in the first droplet 81, a relatively larger amount of genetic scissors md2 may be activated and thus cleave more nucleic acids st of the first reactant md6, resulting in a relatively larger amount of change in the optical or electrical change due to the oxidation reaction or reduction reaction.

On the other hand, when a small amount of target nucleic acid md1 exists in the first droplet 81, a relatively smaller amount of genetic scissors md2 may be activated, resulting in a relatively smaller amount of change in the optical or electrical change due to the oxidation reaction or reduction reaction.

Therefore, by measuring the amount of optical or electrical change due to the oxidation or reduction reaction occurring on the electrode 4113, the presence of the target nucleic acid md1 in the droplet and/or the concentration of the target nucleic acid md1 in the droplet may be determined.

In one embodiment, the third droplet manipulation may be a manipulation of moving the droplet 84 on the fifth electrode 4115 toward the third electrode 4113.

In one embodiment, the third electrowetting signal may be an electric signal (e.g., V1, V2, V3, V4 illustrated in FIG. 37) selectively applied to each of the electrodes 4111, 4112, 4113, 4114, 4115 so that the third droplet manipulation is implemented.

FIG. 58 is a flowchart illustrating a droplet processing method using an electrowetting-based droplet actuator according to an embodiment of the present disclosure. The droplet processing method illustrated in FIG. 58 may be performed by, for example, the droplet actuator 4100 illustrated in FIG. 41. Therefore, when a performer is not specified in the following steps, it is assumed that the performer is the droplet actuator 4100.

Meanwhile, in the following description, the same content as that described above with reference to FIGS. 1 to 57 may be omitted to avoid duplicated explanation.

In the present embodiment, the droplet actuator includes an upper substrate, a lower substrate spaced apart from the upper substrate and having a space formed between the upper substrate and the upper substrate and through which a droplet moves, and a plurality of electrodes arranged on the upper substrate or the lower substrate, and it is assumed that a droplet containing genetic scissors is located on one of the plurality of electrodes and a reactant is located on another one of the plurality of electrodes.

In one embodiment, the droplet may be generated by merging a first droplet containing a target nucleic acid and a second droplet containing genetic scissors by a first droplet manipulation based on a first electrowetting signal.

At this time, the first droplet may be prepared on a first electrode, and a second droplet may be prepared on the second electrode.

The merging of the first droplet and the second droplet by the first droplet manipulation creates the droplet, and the target nucleic acid within the droplet binds to the genetic scissors, thereby activating the genetic scissors. The activated genetic scissors may cleave a nucleic acid.

Meanwhile, the creation of the droplet may not be accomplished by merging the first droplet and the second droplet through droplet manipulation. As described above, the droplet may be injected from the outside while containing an activated protein complex and provided in an internal space of the droplet actuator, e.g., on a fluid channel of the droplet actuator.

In step S100, an electrowetting signal is provided to at least a part of the plurality of electrodes of the droplet actuator.

In step S200, the droplet and the reactant are mixed by a second droplet manipulation based on the electrowetting signal.

At this time, the reactant may be prepared in a state of being contained in a third droplet, or may be prepared in a form fixed on a surface on a fifth electrode. In one embodiment, the reactant may be a combination of a reporter and a quencher bound by a nucleic acid, or a hydrophobic molecule or a hydrophilic molecule bound to a single-stranded nucleic acid.

When the droplet and the reactant are mixed by the second droplet manipulation, the nucleic acid bound to the reactant may be cleaved by the activated genetic scissors. In one embodiment, the bond between the reporter and the quencher in the reactant may be cleaved by the genetic scissors, thereby causing the reporter to be separated from the quencher, or the nucleic acid bound to the reactant may be cleaved by the genetic scissors, thereby causing the reactant to float.

In step S300, the droplet moves to a different position away from a current position by a third droplet manipulation.

In one embodiment, the position to which the droplet moves by the third droplet manipulation may be a position where a reaction of the reactant is more easily measured. For example, the position to which the droplet moves may be a position where a transparent hole is formed at an opposing position or an electrode at the corresponding position is configured as a transparent electrode, in order to enable easier observation of light emission. Alternatively, the position to which the droplet moves may be on another electrode, e.g., a third electrode 4113, away from the reaction electrode 4115 so that the droplet is removed from the reaction electrode 4115 and the degree of hydrophobicity or hydrophilicity of the surface on the electrode 4115 is easily measured.

In step S400, a reaction of the reactant by an action of the genetic scissors is detected.

In one embodiment, the detection of the reaction may involve detecting the amount of light emitted by the reporter, detecting the amount of change in the degree of hydrophobicity or hydrophilicity of the surface on the electrode 4115, or detecting the amount of optical or electrical change due to an oxidation reaction or reduction reaction occurring on the electrode 4113.

In step S500, a result of detecting the reaction is measured, and the presence of the target nucleic acid or the concentration of the target nucleic acid is determined on the basis of the measurement result.

In one embodiment, the presence of the target nucleic acid in the droplet and/or the concentration of the target nucleic acid in the droplet may be determined by measuring the amount of light emitted from the reporter contained in the droplet.

In one embodiment, the presence of the target nucleic acid in the droplet and/or the concentration of the target nucleic acid in the droplet may be determined by measuring the degree of hydrophobicity or hydrophilicity of the surface on the electrode 4115.

In one embodiment, the presence of the target nucleic acid in the droplet and/or the concentration of the target nucleic acid in the droplet may be determined by measuring the amount of optical or electrical change due to the oxidation or reduction reaction occurring on the electrode.

According to the embodiments of the present disclosure described above with reference to FIGS. 41 to 58, it is possible to provide a droplet actuator capable of inducing a biochemical reaction to a substance contained in a droplet on the basis of electrowetting and a droplet processing method using the same. In addition, it is possible to detect the presence and concentration of a target substance in a sample by manipulating genetic scissors on the basis of electrowetting. In addition, in the detection of the target substance, it is possible to apply various types of reactions such as light emission reaction, hydrophilic reaction, hydrophobic reaction, oxidation reaction, or reduction reaction.

Various embodiments of the present disclosure and effects according to the embodiments have been described with reference to the drawings. The effects of the present disclosure are not limited to those mentioned above, and other effects not mentioned will be clearly understood by those skilled in the art from the description herein.

While all elements constituting embodiments of the present disclosure are described as being connected into one body or operating in connection with each other, the disclosure is not limited to the described embodiments. That is, within the scope of the present disclosure, one or more of the elements may be selectively connected to operate.

Although preferred embodiments of the present disclosure have been described with reference to the accompanying drawings, it will be apparent to those skilled in the art that the present disclosure may be embodied in specific forms other than those set forth herein without departing from the spirit and essential characteristics of the present disclosure. Therefore, the above embodiments should be construed in all aspects as illustrative and not restrictive. The scope of the disclosure should be determined by the appended claims and their legal equivalents, and all changes coming within the meaning and equivalency range of the appended claims are intended to be embraced therein.

What is claimed is:

1. A droplet actuator, comprising:
a base plate formed of an insulator; and
at least one electrode formed through the base plate and configured to move a fluid located on a surface of the at least one electrode on the basis of an applied voltage,
wherein the at least one electrode is formed by injecting a conductive polymer into an empty space of the base plate using an injection gate.

2. The droplet actuator of claim 1, wherein the conductive polymer includes a compound of a polymer and a metal.

3. The droplet actuator of claim 2, wherein the polymer includes siloxane, resin, PLA, ABS, nylon, PETG, TPU, ASA, PEI, or epoxy.

4. The droplet actuator of claim 2, wherein the metal includes gold (Au), silver (Ag), or copper (Cu).

5. The droplet actuator of claim 1, wherein the conductive polymer includes a compound of a polymer and carbon, carbon nanotubes (CNT), carbon fiber, graphite, or graphene.

6. The droplet actuator of claim 1, wherein the base plate is formed by injecting the insulator into a space of a mold using another injection gate that is distinct from the injection gate.

7. The droplet actuator of claim 1, wherein the base plate is formed by press molding of the insulator or by flat plate drilling.

8. The droplet actuator of claim 1, wherein the base plate is formed by 3D printing of the polymer.

9. The droplet actuator of claim 1, wherein an upper width of the electrode is larger than a middle width of the electrode by a first reference size, and a lower width of the electrode is larger than the middle width of the electrode by a second reference size,
wherein the first reference size is larger than the second reference size.

10. The droplet actuator of claim 9, wherein a width of the electrode is tapered from an upper portion toward a middle portion of the electrode, and is tapered from a lower portion toward the middle portion of the electrode.
